(19) United States
(12) Patent Application Publication
(10) Pub. No.: US 2006/0114918 A1
(43) Pub. Date: Jun. 1, 2006

(54) Data transfer system, data transfer method, and image apparatus system

(76) Inventors: Junichi Ikeda, Miyagi (JP); Koji Oshikiri, Miyagi (JP); Atsuhiro Oizumi, Miyagi (JP); Yutaka Maita, Miyagi (JP); Satoru Numakura, Miyagi (JP); Noriyuki Terao, Miyagi (JP); Yasuyuki Shindoh, Miyagi (JP); Tohru Sasaki, Iwate (JP); Koji Takeo, Miyagi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/125,207

(22) Filed: May 10, 2005

(30) Foreign Application Priority Data
Nov. 9, 2004 (JP) 2004-324553
Nov. 9, 2004 (JP) 2004-324555
Nov. 9, 2004 (JP) 2004-324556

(51) Int. Cl. H04L 12/56

(52) U.S. Cl. 370/408

(57) ABSTRACT

A data transfer system using a high-speed serial interface system that forms a tree structure in which point-to-point communication channels are established for data sending and data receiving independently is provided. The data transfer system includes plural end points each having plural upper ports each of which is connected to a switch of an upper side, wherein each end point includes a port selecting part for selecting a port to be used according to an operation mode of the data transfer system so as to dynamically change the tree structure.

### BACKGROUND OF THE INVENTION

1. Field of the Invention

The present invention relates to a data transfer technology, and relates to an image system such as a compound machine (also to be referred to as MFP).

2. Description of the Related Art

Generally, apparatuses and systems that deal with image data and other data use a PCI bus as an interface between devices. However, in the PCI bus that adopts parallel data transfer, there are problems such as racing and skew, and the transfer rate of the PCI bus is not enough for use in a high-speed/high-quality image apparatus. Recently, instead of the parallel interface such as the PCI bus, use of a high-speed serial interface is being studied. As widely used serial interfaces, IEEE1394, USB and the like are previously known. However, the transfer rate of these interfaces are less than the PCI. In addition, there is a problem in that it is difficult to keep scalable bus widths in these interfaces. Thus, as another high-speed serial interface, use of PCI Express that is a succeeding standard of the PCI is being studied.

In outline, the PCI Express system is configured as a data communication network of a tree structure shown in FIG. 1 in a document 1 (Satomi, “Outline of PCI Express standard”, Interface, July, 2003).

An simplified example is shown in FIG. 1. As shown in the FIG. 1, the PCI Express system 200 includes a root node (root complex) 201, as a top of the tree structure, for managing the system. In addition, plural end nodes (end points) A, B, C, D, . . . are connected to the root complex 201 via switches SW1, SW2, SW3, . . . to form a tree structure. Each of the switches SW1, SW2, SW3, . . . includes an upper port (root node side), and plural lower ports (end node side). Each of the devices A, B, C, D, . . . includes only one port. Each communication route between devices is uniquely determined in the tree structure.

Each pair of nodes in the system are connected beforehand by a connection line of a speed necessary for data transfer between the nodes. The connection lines can be different with each other, in which the number of lanes that indicate a bus width of a connection line is '8, ×4, ×2 or the like. As to the switches SW1, SW2, SW3, . . . , by setting a priority in each port, the transfer speed can be adjusted when plural data transfers are processed in parallel (when contention occurs).

However, since the communication route is fixed when simply using the PCI Express system, contention for a data transfer route may occur so that transfer efficiency deteriorates when plural independent data transfers are processed in parallel.

For example, in the example shown in FIG. 1, when two data transfers are processed at the same time wherein one data transfer is via a route 202 from the root node 201 to the end node A and another data transfer is via a route 203 from the end node C to the end node B, contention in a lower port to the switch SW 2 in the switch SW 1 occurs as shown in a magnified view in FIG. 1 Therefore, when a packet of the route 202 and a packet of the route 203 are alternately output, the transfer rate decreased to half so that the transfer efficiency deteriorates. Although it is possible to give precedence to one route 202 or 203 by performing arbitration in the switch SW 1, transfer efficiency of another route further deteriorates.

The contention shown in FIG. 1 can be avoided by changing connections of the end nodes A, B, C and D to the switches SW 2 and SW 3 as shown in FIG. 2, for example. However, even in the connections shown in FIG. 2, if the process for the route 202 and a process for a route 204 from the end node C to the end node C should be performed at the same time, contention occurs in the same way as FIG. 1, so that transfer rate deteriorates. Thus, the change of connections is not a substantial solution.

Such deterioration of the data transfer rate occurs not only when the contention for a data transfer route occurs but also when the data transfer route passes through more than necessary number of switches.

In addition, since the data transfer route is statically determined, there is no software solution means when a bottleneck occurs.

In addition, when a route that passes through the root complex of the tree structure is used for data transfer between devices, speed of the data transfer may be decreased, so that, in such a case, it is difficult to say that the function of the PCI Express is fully utilized.

More particularly, when the route that passes through the root complex is used in data transfer, contention is likely to occur at an output port in a switch existing between the device and the root complex, so that the transfer rate is decreased. As mentioned before, such deterioration of the data transfer rate occurs not only when the contention for a data transfer route occurs but also when the data transfer route passes through more than necessary number of switches. At this viewpoint, when adopting a configuration in which the route that passes through the root complex is used, cases where a data transfer route passes through multiple number of switches may increase so that there is a risk in that the data transfer rate decreases.

In addition, as to the image apparatus, more increased speed and higher performance are being required. But, if all functions are included in a single image apparatus, the cost becomes high, and the image apparatus may include many useless functions since the high-speed and high performance functions are not always used.

### SUMMARY OF THE INVENTION

An object of the present invention is to improve the data transfer efficiency by avoiding contention for a port and by avoiding using a data transfer route that passes through more than necessary number of switches.

The above object is achieved by a data transfer system using a high-speed serial interface system that forms a tree structure in which point-to-point communication channels are established for data sending and data receiving independently, the data transfer system including:

plural end points each having plural upper ports each of which is connected to a switch of an upper side, wherein each end point includes a port selecting part for selecting a port to be used according to an operation mode of the data transfer system so as to dynamically change the tree structure.

In the data transfer system, the port selecting part includes a memory for rewritably storing port selection information of an upper port to be selected when reset of link is performed;

each end point further includes an updating part for updating the port selection information in the memory by receiving a message packet including the port selection information;

the data transfer system further includes:

an initialization part for performing link-up in a status in which upper ports are selected according to port selection information in the memory in each end point when the data transfer system is activated, and for obtaining the tree structure in the initial status and specifying device functions and necessary data transfer performances for each end point;

a determination part for determining an upper port optimum for the operation mode by referring to the specified device functions and the necessary data transfer performances of each end point;

a notification part for sending the message packet including the port selection information to the updating part of a corresponding end point such that the port selection information in the memory of the end point is updated; and

a re-link-up part for performing re-link-up in a status in which an upper port is selected in each end point according to the updated port selection information;

wherein the data transfer system starts to perform data transfer according to the operation mode after the re-link-up is performed.

According to the above-mentioned present invention, by providing the plural upper ports in each end points and selecting an upper port according to an operation mode, the tree structure can be dynamically changed. Therefore, even when plural independent data transfers are processed in parallel, contention in data transfer routes can be avoided by keeping independent data transfer routes. In addition, a data transfer route that passes through more than necessary number of switches can be avoided. Therefore, the data transfer efficiency can be improved.

The above object is also achieved by a data transfer system using a high-speed serial interface system that forms a tree structure in which point-to-point communication channels are established for data sending and data receiving independently, the data transfer system including devices at a lower side of the tree structure, each of the devices including:

plural end points being connected to plural switches of an upper side of the tree structure; and

an arbiter for determining an end point to be used according to an operation mode of the data transfer system.

The above object is also achieved by a data transfer system using a high-speed serial interface system that forms a tree structure in which point-to-point communication channels are established for data sending and data receiving independently, the data transfer system including devices at a lower side of the tree structure, each of the devices including:

plural end points being connected to plural switches of an upper side of the tree structure;

an arbiter for determining an end point to be used for accessing other device; and

an information storing part for storing information on a device function of the own device and information on end points such that a management part of the data transfer system can access the information,

the management part of the data transfer system including:

a determination part for determining an optimum route between devices in the tree structure based on a device connection status, the information on the device function and the information on the end points obtained from each device; and

a setting part for setting the determined route information in each device,

wherein the arbiter in each device determines the end point used for accessing other device by referring to the determined route information set by the setting part.

The present invention can be configured as a data transfer system using a high-speed serial interface system that forms a tree structure in which point-to-point communication channels are established for data sending and data receiving independently, the data transfer system including devices at a lower side of the tree structure, each of the devices including:

plural end points being connected to plural switches of an upper side of the tree structure; and

an arbiter for determining an end point to be used for accessing other device,

the data transfer system further including an management part including:

an information management part for storing information on a device function of each device and information on end points;

a determination part for determining an optimum route between devices in the tree structure based on a device connection status, the information on the device function and the information on the end points stored in the information management part; and

a setting part for setting the determined route information in each device,

wherein the arbiter in each device determines the end point used for accessing other device by referring to the determined route information set by the setting part.

According to the above-mentioned present invention, by providing the plural end points in each device and determining an end point according to an operation mode, the tree structure can be dynamically changed. Therefore, even when plural independent data transfers are processed in parallel, contention in data transfer routes can be avoided by keeping independent data transfer routes. In addition, a data transfer route that passes through-more than necessary number of switches can be avoided. Therefore, the data transfer efficiency can be improved. Especially, according to the present invention, the route can be set such that it does not pass through the root of the tree structure. Thus, data communication can be performed efficiently irrespective of bandwidth of the root part. Further, even in a system in which communication bandwidth necessary between devices change according to operation status, optimum communication bandwidth can be always maintained by changing route setting.

The present invention can be also configured as an image apparatus system using a high-speed serial interface system that forms a tree structure in which point-to-point communication channels are established for data sending and data receiving independently, the image apparatus system including:

plural image apparatuses having different performance, wherein each of the plural image apparatuses is connected to a switch, and includes devices at least including a control part and a storage; and

a root complex to which plural switches are commonly connected.

The image apparatus system may include plural root complexes, and an advanced switch to which the plural root complexes are commonly connected.

According to the present invention, since each image apparatus is connected to a switch that is a top in a tree structure without data transfer via the root complex, the speed of the data transfer can be increased compare with a case where the data pass through the root complex. Generally, high-cost is required if all functions are included in a image apparatus. In contrast, according to the present invention, since plural image apparatuses having different performances are connected via the root complex so that the image apparatuses having different performances can communicate with each other. Therefore, even when desired image processing (for example, high-speed processing, color printing, laser printing, wide width paper printing or the like) cannot be performed by one image apparatus (for example, low-speed, black and white, inkjet printing, A3 size or the like), the desired image processing can be realized by using resources of another image apparatus. Further, by using the advanced switch, plural image apparatus systems can be connected.

The present invention can be also configured as an image system using a high-speed serial interface system that forms a tree structure in which point-to-point communication channels are established for data sending and data receiving independently, the image system including plural devices existing at end points in a lower side of the tree structure,

wherein, in the plural devices, particular devices having strong correlation with each other are connected to an upper side via a common switch.

According to the present invention, since the devices having the strong correlation with each other are connected to the upper side of the tree structure via the common switch, data transfer among the devices having strong correlation only passes through the common switch. Thus, contention for an output port of a switch can be avoided as much as possible, and the number of switches through which a data transfer route passes can be decreased as much as possible. Therefore, the speed of the data transfer can be further increased compared with the case where the route passes through the root complex.

### BRIEF DESCRIPTION OF THE DRAWINGS

Other objects, features and advantages of the present invention will become more apparent from the following detailed description when read in conjunction with the accompanying drawings, in which:

FIG. 1 is a principle schematic diagram showing an example of a tree structure in normal use of the PCI Express;

FIG. 2 show a modified example of the tree structure of the PCI Express;

FIG. 3 is a block diagram showing a configuration example of an existing PCI system;

FIG. 4 is a block diagram showing a configuration example of a PCT Express system;

FIG. 5 is a block diagram showing an actual example of a PCI Express platform;

FIG. 6 is a schematic diagram showing a structure of the physical layer adopting ×4;

FIG. 7 is a schematic diagram showing an example of lane connections between devices;

FIG. 8 is a block diagram showing a logical structure example of a switch;

FIG. 9A is a block diagram showing an architecture of the existing PCI;

FIG. 9B is a block diagram showing an architecture of the PCI Express;

FIG. 10 is a block diagram showing the layered structure of the PCI Express;

FIG. 11 shows an example of a transaction layer packet (TLP);

FIG. 12 is a diagram showing configuration spaces of the PCI Express;

FIG. 13 is a diagram for explaining the concept of the virtual channel;

FIG. 14 shows a format example of a data link layer packet;

FIG. 15 is a schematic diagram showing a bye striping example in ×4 link;

FIG. 16 shows a table for explaining power management;

FIG. 17 is a time chart showing a control example in active state power management;

FIG. 18 is a principle schematic diagram of an example of the tree structure of the data transfer system of a first embodiment;

FIGS. 19A and 19B show an image forming system as a preferred example of the data transfer system of the first embodiment;

FIG. 20 is a schematic block diagram of a configuration example of an end point 21;

FIG. 21 is a principle schematic diagram showing an example of a tree structure in a link-up state when the system is activated;

FIG. 22 is a principle schematic diagram showing an operation mode example in which port contention occurs in a switch in the initial setting state;

FIG. 23 is a principle schematic diagram showing a tree structure example in a state in which re-link-up is completed before actual data transfer;

FIG. 24 is a principle schematic diagram showing an operation mode example under a tree structure after completing re-link-up;

FIG. 25 is a schematic flowchart showing an operation control example performed by the CPU 16;

FIG. 26 is a schematic flowchart showing operation examples in each end point (21A-21D);

FIG. 27 is a principle schematic diagram showing a tree structure example in a link-up state when the system is activated;

FIG. 28 is a principle schematic diagram showing an operation-mode example under a tree structure after completing re-link-up;

FIG. 29 is a graph showing characteristics in a case where four different types of traffics are started at the same time and each traffic is completed in an order of a transmission speed;

FIG. 30 is a graph showing relationships between payload sizes and transfer rates in which the number of switches through which data pass is used as a parameter;

FIG. 31 is a principle schematic diagram of an example of the tree structure of the data transfer system of a second embodiment;

FIG. 32 is an image forming system that is a preferred example of a data transfer system of the present embodiment;

FIG. 33 is a schematic flowchart showing an example of a method of managing route information according to the second embodiment;

FIG. 34 is a schematic flowchart showing another example of a method of managing route information according to the second embodiment;

FIG. 35 is a schematic flowchart showing an example of timing control in the method of managing route information according to the second embodiment;

FIG. 36 is a schematic flowchart showing another example of timing control in the method of managing route information according to the second embodiment;

FIG. 37 is a principle schematic diagram of an example of the tree structure of the image apparatus system of a third embodiment;

FIG. 38 shows an expanded example of the tree structure of the image apparatus system of the third embodiment;

FIG. 39 shows a modified example of the tree structure of the image apparatus system of the third embodiment;

FIG. 40 is a principle schematic diagram of an example of the tree structure of the image system of a fourth embodiment;

FIG. 41 is a schematic block diagram showing devices having strong correlation;

FIG. 42 is a schematic block diagram showing a modified example of devices having strong correlation;

FIG. 43 is a schematic block diagram showing a modified example of devices having strong correlation;

FIG. 44 is a schematic block diagram showing a modified example of devices having strong correlation;

FIG. 45 is a schematic block diagram showing a modified example of devices having strong correlation;

FIG. 46 is a schematic block diagram showing a modified example of devices having strong correlation;

FIG. 47 is a schematic block diagram showing a modified example of devices having strong correlation;

FIG. 48 is a schematic block diagram showing a modified example of devices having strong correlation;

FIG. 49 is a schematic block diagram showing a modified example of devices having strong correlation;

FIG. 50 is a schematic block diagram showing a modified example of devices having strong correlation;

FIG. 51A shows a conventional configuration example in which devices A, B, C, a, b and c are connected to the switches SW2 and SW3 irrespective of correlation;

FIG. 51B shows a configuration example of an embodiment of the present invention in which devices having strong correlation are grouped.

### DETAILED DESCRIPTION OF THE PREFERRED EMBODIMENTS

In the following embodiments of the present invention are described with reference to figures.

[Outline of PCI Express Standard]

The present embodiments use PCI Express that is one of high-speed serial buses. Thus, an outline of the PCI Express standard is described first. The following descriptions are partial excerpts from the document 1. The high-speed serial bus means an interface by which data can be exchanged at high speed (more than about 100 M bps) by using serial transmission using one transmission line.

The PCI Express is a standard expansion bus that is standardized as a successor to PCI and that can be used for all computers. In outline, the PCI Express has characteristics that are low voltage differential signal transmission, point-to-point communication channel in which sending and receiving are independent of each other in, packetized split transaction, high scalability based on difference of link configuration and the like.

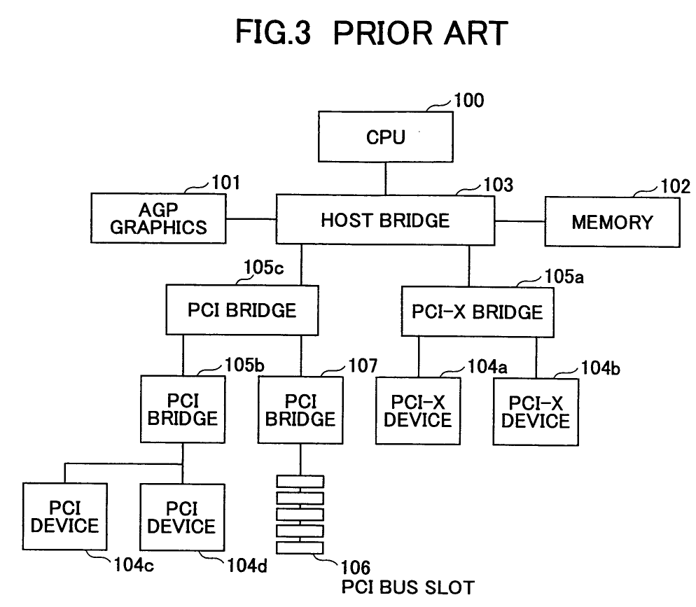

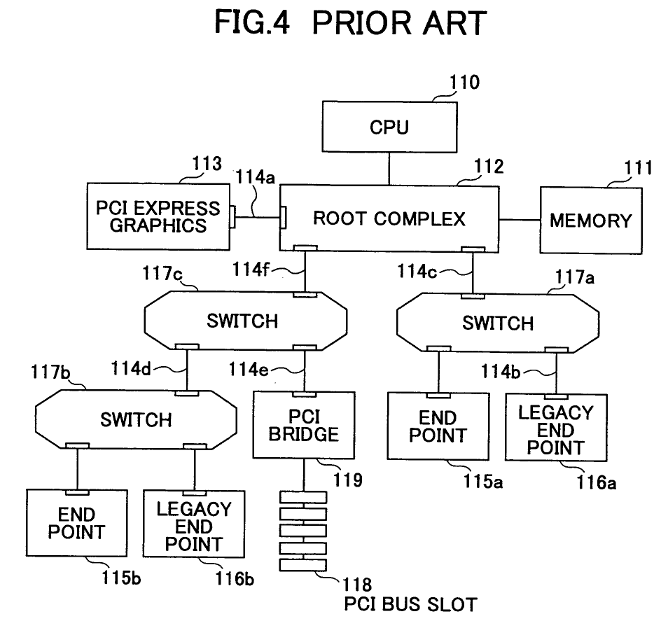

FIG. 3 shows a configuration example of an existing PCI system. FIG. 4 shows a configuration example of a PCT Express system. The existing PCI system has a tree structure in which a CPU 100, an AGP graphics 101 and a memory 102 are connected to a host bridge 103, PCI-X devices 104a and 104b are connected to the host bridge via a PCI-X bridge 105a, a PCI bridge 105b to which PCI devices 104c and 104d are connected is connected to the host bridge via a PCI bridge 105c, and a PCI bridge 107 to which a PCI bus slot 106 is connected is connected to the host bridge 105c via the PCI bridge 105c.

On the other hand, the PCI Express system has a tree structure as shown in FIG. 4. In the PCI Express system, a CPU 110 and a memory 111 are connected to a root complex 112. A PCI Express graphics 113 is connected the root complex 112 via the PCI Express 114a. An end point 115a and a legacy end point 116a are connected to a switch 117a via a PCI Express 114b that is connected to the root complex 112 via a PCI Express 114c. Further, an end point 115b and a legacy end point 116b are connected to a switch 117b via a PCI Express 114d. The switch 117b is connected to a switch 117c, and a PCI bus slot 118 is connected to a PCI bridge 119 that is connected to the switch 117c via a PCI Express 114e. The switch 117c is connected to the root complex 112 via a PCI Express 114f.

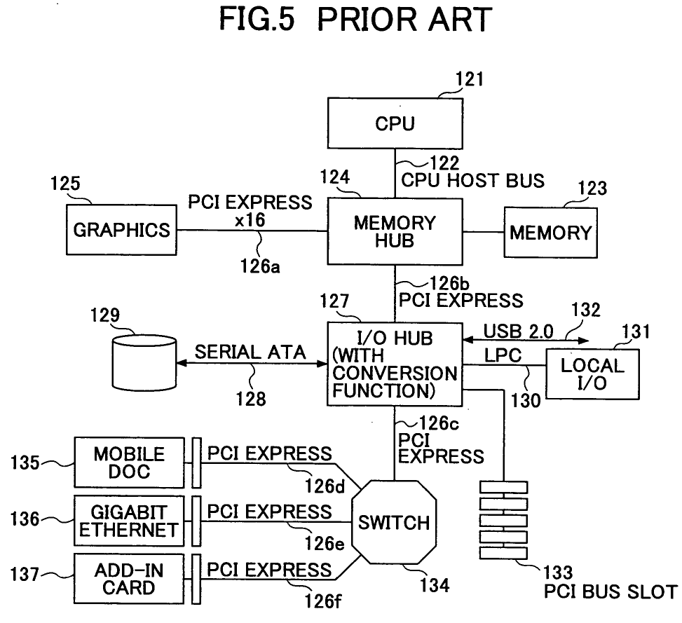

FIG. 5 shows an actual example of a PCI Express platform. The example shown in FIG. 5 is an example applied to a desktop/mobile environment. In the platform, a CPU 121 is connected to a memory hub 124 (corresponding to the root complex) via a CPU host bus 122, and the memory 123 is connected to the host bus 124. A graphics 125, for example, is connected to the memory hub 124 via a ×16 PCT Express 126a, and an I/O hub 127 that includes a conversion function is connected to the memory hub 124 via a PCI Express 126b. A storage 129, for example, is connected to the I/O hub 127 via a Serial ATA 128, and a USB2.0 (132) and a PCI bus slot 133 are connected to the I/O hub 127. Further, a switch 134 is connected to the I/O hub 127 via a PCI Express 126c. In addition, a mobile doc 135, a gigabit Ethernet 136 and an add-in card 137 are connected to the switch 134 via PCI Expresses 126d, 126e and 126f respectively.

That is, in the PCI Express system, conventional buses such as PCI, PCI-X and AGP are replaced by the PCI Expresses, and a bridge is used for connecting existing PCI/PCI-X devices. Connections between chip sets are also replaced by PCI Express connections, and existing buses such as IEEE1394, Serial ATA and USB 2.0 are connected to the PCI Express by the I/O hub.

[Components of PCI Express]

A. Port/Lane/Link

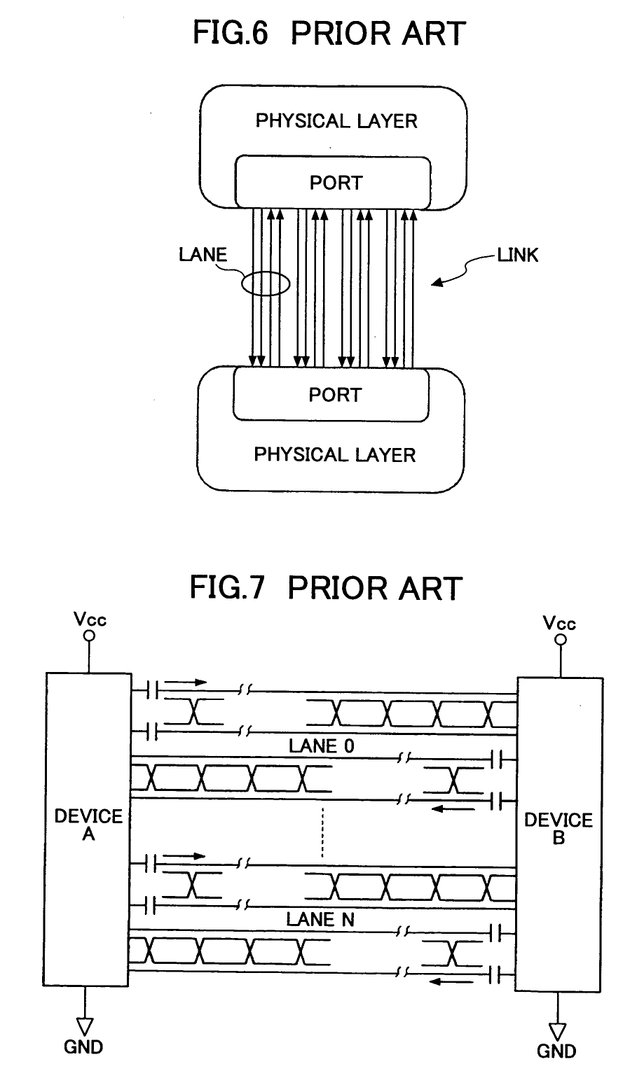

FIG. 6 shows a structure of the physical layer. Physically, the port exists within the same semiconductor, and is a set of transmitters and receivers for forming links. Logically, the port means an interface that connects between components in a one-to-one relationship. The transmission rate is determined to be 2.5 Gbps in an one-way direction, for example. The lane is a set of differential signal pairs of 0.8V, for example, and includes a signal pair (two signals) in the sending side and a signal pair (two signals) in the receiving side. The link is a dual simplex communication bus between components, and includes two ports and a set of lanes each connecting between the two ports. “×N link” means N lanes, and N=1, 2, 4, 8, 16 and 32 are defined in the current standard. FIG. 6 shows an example of the ×4 link. For example, as shown in FIG. 7, by configuring a lane width N between devices A and B to be changeable, a scalable bandwidth can be realized.

B. Root Complex

The root complex 112 exists in the top of the I/O structure, and connects a CPU and a memory subsystem to I/O. Generally, the root complex 112 is referred to as “memory hub” in block diagrams as shown in FIG. 5. The root complex 112 (or 124) includes PCI Express ports (root ports) no less than one (shown as boxes in FIG. 4 in the root complex 112), and each port forms an independent I/O layer domain. The I/O layer domain may be a simple end point (the end point 115a side in FIG. 4, for example), or may be formed by multiple switches and end points (a side of the end point 115b and switches 117b and 115c in FIG. 4, for example).

C. End Point

The end point 115 is a device (more particularly, a device other than the bridge) having a configuration space header of type 00h, and the end point 115 can be classified to a legacy end point and a PCI Express end point. The PCI Express includes BAR (base address register) and basically does not request I/O port resources, thus, the PCI Express does not send any I/O request. In addition, the PCI Express end point does not support lock request. These are the main difference between the legacy end point and the PCI Express end point.

D. Switch

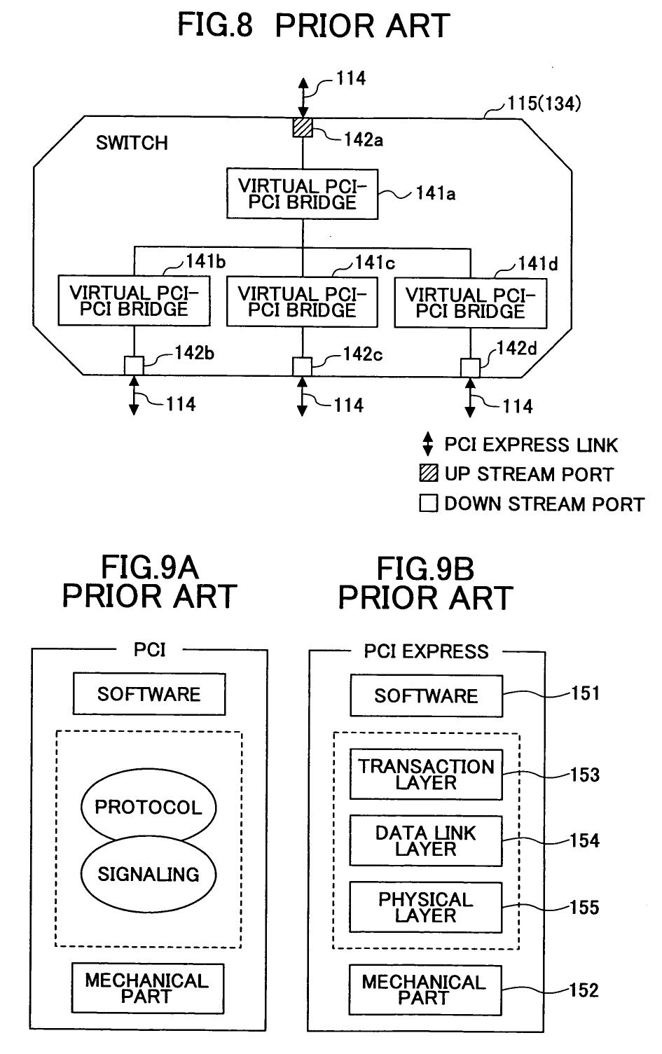

The switch 117 (or 134) connects more than one ports and performs packet routing between the ports. As shown in FIG. 8, the switch is recognized as a set of virtual PCI-PCI bridges. In the figure, each double-headed arrow indicate a PCI Express link 114 (or 126), and 142a-142d indicate ports. In the ports, the port 142a is an up-stream port near the root complex, each of the ports 142b-142d is a down stream port that is far from the root complex.

E. PCI Express-114e—PCI bridge 117

The PCI Express 114e and the PCI bridge 117 provides a connection from PCI Express to PCI/PCI-X. Accordingly, existing PCI/PCI-X devices can be used on the PCI Express system.

[Layered Architecture]

As shown in FIG. 9A, in the structure of the architecture of the conventional PCI, protocols and signaling are closely related to each other, and there is no concept of the layer. On the other hand, as shown in FIG. 9B, the PCI Express has a layered structure in which specifications are defined for each layer independently like general communication protocols and InfiniBand. That is, in the structure, a transaction layer 153, a data link layer 154 and a physical layer 155 exist between the top software 151 and the bottom mechanical part 152. By adopting such a structure, modularity of each layer is maintained so that scalability can be increased and reuse of module can be realized. For example, a new signal coding method or a new transmission medium can be adopted only by changing the physical layer without changing the data link layer and the transaction layer.

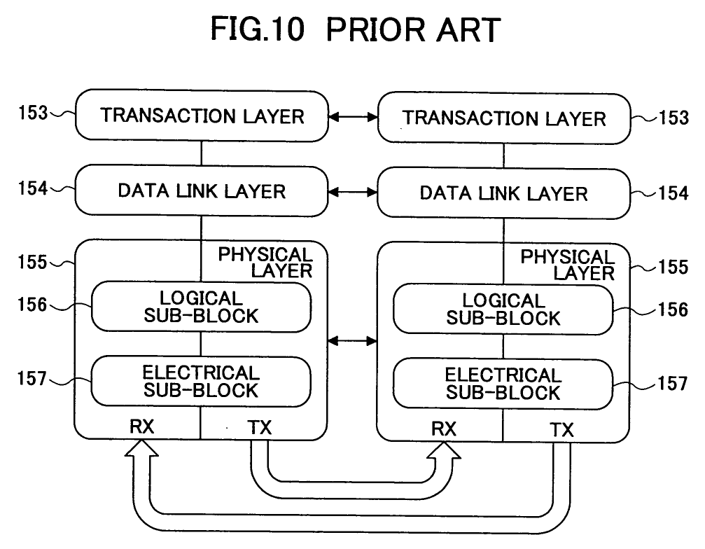

The core of the architecture of the PCI Express is the transaction layer 153, the data link layer 154 and the physical layer 155 each of which has functions as described in the following with reference to FIG. 10.

A. Transaction layer 153

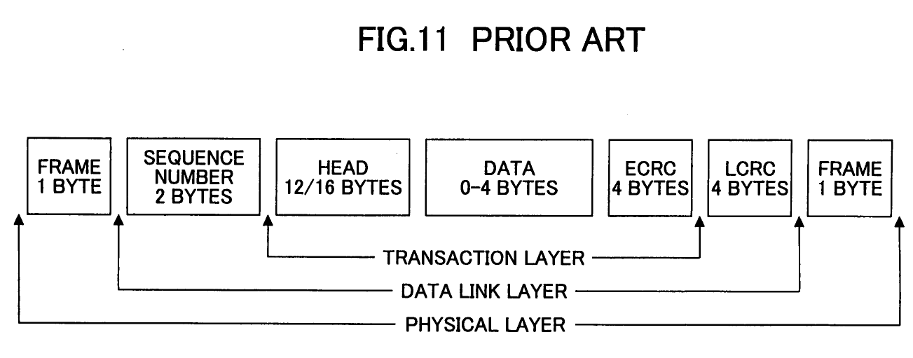

The transaction layer 153 exists in the top layer, and has functions for assembling and disassembling a transaction layer packet (TLP). The transaction layer packet (TLP) is used for transmission of a transaction such as reading/writing, various events and the like. In addition, the transaction layer 153 performs flow control using a credit for the transaction layer packet (TLP). FIG. 11 shows the transaction layer packet (TLP), the details of which will be described later.

B. Data link layer 154

Main functions of the data link layer 154 are ensuring data completeness of the transaction layer packet (TLP) by performing error detection/correction (retransmission), and performing link management. Packets for link management and flow control are exchanged between data link layers 154. The packet is called a data link layer packet (DLLP) to be distinguished from the transaction layer packet (TLP).

C. Physical layer 155

The physical layer 155 includes circuits necessary for interface operations such as a driver, an input buffer, parallel-serial/serial-parallel converter, a PLL and an impedance matching circuit. In addition, as logical functions, the physical layer 155 includes initialization and maintenance functions. The physical layer 155 also has a function for separating the data link layer 154 and the transaction layer 153 from signal technology that is used for actual links.

A technology called embedded clock is adopted in the hardware configuration of the PCI Express, so that there is no clock signal and the timing of a clock is embedded in the data signal, so that a receiving side extracts the clock based on a cross point of the data signal.

[Configuration Space]

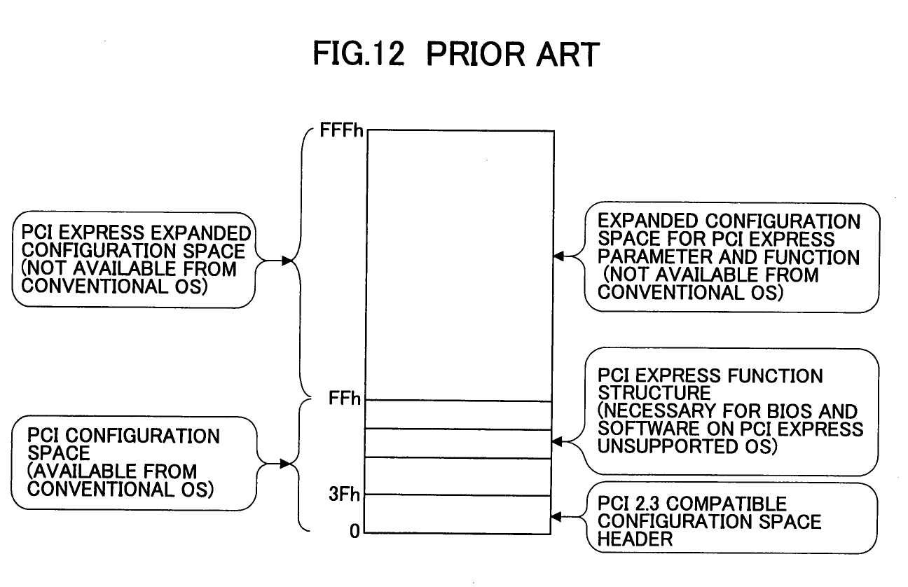

Like the conventional PCI, the PCI Express has a configuration space. The size of the configuration space of the conventional PCI is 256 bytes. In contrast, the size is expanded to 4096 bytes in PCI Express as shown in FIG. 12. Thus, enough space is kept in years to come even for devices (such as Host Bridge) that require many device specific register sets. In the PCI Express, access to the configuration space is performed as access (configuration read/write) to a flat memory space, and bus/device/function/register numbers are mapped to memory addresses.

The first 256 bytes of the space can be accessed as a PCI configuration space even by a method using I/O port from BIOS or conventional OS. The function for converting the conventional access to the access in the PCI Express is implemented on the host bridge. The region from 00h to 3Fh is a configuration header compatible with PCI2.3. Thus, functions of PCI Express other than expanded functions can be used by a conventional OS and software as it is. That is, the software layer of the PCI Express inherits the load store architecture compatible with the existing PCI, in which the load store architecture is a method in which a processor directly accesses an I/O register. However, for using the expanded function in the PCI Express, it is necessary to be ale to access 4k byte PCI Express expanded space, wherein the expanded function is synchronized transfer, RAS (Reliability, Availability and Serviceability) and the like.

The PCI Express may take various form factors. Concrete examples are an add-in card, a plug-in card (Express Card), Mini PCI Express and the like.

[Details of the Architecture of the PCI Express]

In the following each of the transaction layer 153, the data link layer 154 and the physical layer 155 that are the core of the architecture of the PCI Express are described in detail.

A. Transaction layer 153

As mentioned before, the main function of the transaction layer 153 is assembling and disassembling of the transaction layer packet (TLP) between the upper software layer 151 and the lower data link layer 154.

a. Address Space and Transaction Type

In the PCI Express, a message space is added in addition to a memory space (for data transfer with memory space), an I/O space (for data transfer with I/O space), a configuration space (for device configuration and setup) that are also supported in the conventional PCI and, four address spaces are defined. The message space is for event notification in in-band between PCI Express devices and for general message transmission (exchange), in which interrupt request and acknowledgment are transmitted by using the message as “virtual wire”. A transaction type is defined for each space, in which each of the memory space, I/O space and configuration space is read/write, and the message space is basic (including vendor definition).

b. Transaction Layer Packet (TLP)

In the PCI Express, communications are performed in units of packet. In the format of the transaction layer packet shown in FIG. 11, a header length of the header is 3DW (DW is abbreviation of double words, that is, 3DW means 12 bytes) or 4 DW (16 bytes), and the header includes information such as a format (header length and presence or absence of payload) of the transaction layer packet (TLP), transaction type, traffic class (TC), attribute and payload length. Maximum payload length in a packet is 1024 DW (4096 bytes) ECRC is for ensuring data completeness in end-to-end, and is 32 bit CRC in the transaction layer packet (TLP). This is provided since LCRC (link CRC) cannot detect an error when the error occurs in the transaction layer packet (TLP) in the inside of the switch (since LCRC is recalculated in the TLP in which the error occurs).

There are two types of request that requires a complete packet and that does not require the complete packet.

c. Traffic Class (TC) and Virtual Class (VC)

The upper software can differentiate traffic (assign priorities) by using the traffic class (TC). For example, it becomes possible to transfer image data first. The traffic classes include eight classes from TC0 to TC7.

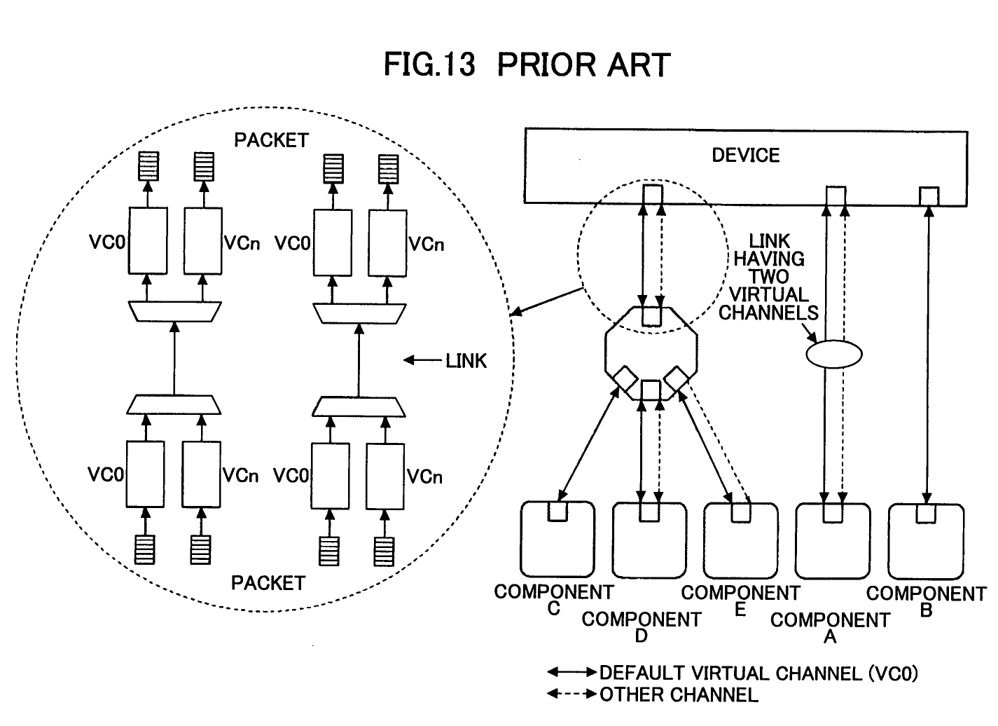

Each of the virtual channels (VC: Virtual Channel) is an independent virtual communication bus, that is a mechanism for using plural independent data flow buffers that share the same link. Each of the virtual channel has a resource (buffer or queue), and performs independent flow control as shown in FIG. 13. Accordingly, even when a buffer of a virtual channel becomes full, data transfer can be performed by using other virtual channels. That is, one physical link can be efficiently used by dividing the link into plural virtual channels. For example as shown in FIG. 13, when a root link is divided to plural devices via a switch, priorities of traffic of each device can be controlled. VC 0 is essential, and other virtual channels (VC 1-VC 7) are implemented according to trade-offs of cost-performance. The solid line with an arrow in FIG. 13 shows a default virtual channel (VC 0), and a dotted line with an arrow indicates the other virtual channel (VC 1-VC 7).

In the transaction layer, the traffic class is mapped to the virtual channel (VC). One or more traffic classes (TC) can be mapped to one virtual channel (VC) when the number of the virtual channels is small. In simple examples, it can be considered that each traffic class (TC) is mapped to each virtual channel (VC) in a one-to-one relationship, and that every traffic class (TC) is mapped to the virtual channel VC 0. A mapping of TC 0-VC 0 is indispensable and fixed, and other mapping is controlled by the upper software. By using the traffic class (TC), the software can control priority of transaction.

d. Flow Control

The flow control (FC) is performed for avoiding overflow of the receiving buffer and to establish transmission order. The flow control is performed in a point-to-point manner, not end-to-end. Therefore, it is not possible to check whether a packet reaches a final communication partner (to be referred to as completer) by the flow control.

The flow control of the PCI Express is performed in a credit base that is a mechanism for checking occupancy status of the buffer of the receiving side before starting data transfer to avoid overflow and underflow. That is, the receiving side sends a buffer capacity (credit value) to the sending side at the time of initialization, and the sending side compares the credit value with a length of a packet to be transmitted so as to send it only when there is a predetermined remaining capacity. There are six types of credits.

Information exchange in the flow control is performed by using the data link layer packet (DLLP). The flow control is applied only to the transaction layer packet (TLP), and is not applied to the data link layer packet (DLLP). Thus, DLLP can always be sent and received.

B. Data Link Layer 154

As described before, the main function of the data link layer 154 is to provide a reliable exchange function for the transaction layer packet (TLP) between two components on a link.

a. Handling of the Transaction Layer Packet (TLP)

For the transaction layer packet (TLP) received from the transaction layer 153, a two-byte sequence number is added at the head, and a four-byte link CRC (LCRC) is added at the end, and the transaction layer packet (TLP) with the sequence number and the link CRC is passed to the physical layer 155 (refer to FIG. 11). The transaction layer packet (TLP) is stored in a retry buffer so as to be retransmitted until an acknowledgment (ACK) is received from the communication partner. When the transmission of the transaction layer packet (TLP) continues to fail, it is judged that link failure occurs and re-training of the link is requested to the physical layer 155. When the training of the link fails, the status of the data link layer is changed to inactive.

As to the transaction layer packet (TLP) received from the physical layer 155, the sequence number and the link CRC (LCRC) are checked. If there is no problem, the transaction layer packet (TLP) is passed to the transaction layer 153, and if there is an error, retransmission is requested.

b. Data Link Layer Packet (DLLP)

The packet generated by the data link layer 154 is called a data link layer packet (DLLP) and is exchanged between data link layers 154. There are following types of the data link layer packet (DLLP):

Ack/Nack: acknowledgement of TLP, retry (retransmission);

InitFC1/InitFC2/UpdateFC: initialization and update of flow control; and

DLLP for power management.

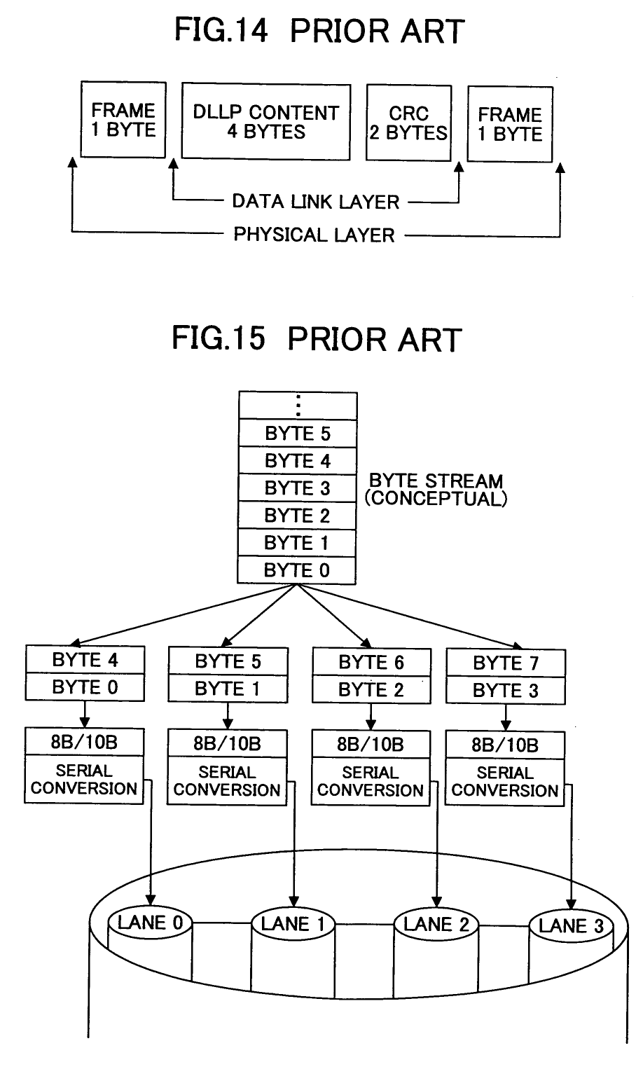

As shown in FIG. 14, the length of the data link layer packet (DLLP) is six bytes, including DLL type (one byte) indicating the type, information (three bytes) specific to the type, and CRC (two bytes).

C. Physical Layer—Logical Sub-block 156

The main function of the logical sub-block 156 of the physical layer 155 in FIG. 10 is to convert a packet received from the data link layer 154 to a form that can be sent by a electronic sub-block 157. In addition, the logical sub-block 156 includes a function for controlling and managing the physical layer 155.

a. Data Coding and Parallel-Serial Conversion

The PCI Express uses 8B/10B conversion in data coding such that consecutive “0” or “1” does not appear, that is, such that a state in which any cross-point does not exist does not continue for a long time. As shown in FIG. 15, the converted data is converted to serial data that are transmitted over a lane from LSB. When there are plural lanes (FIG. 15 shows a case of ×4 links), data are assigned to each lane for each byte before coding. In this case, although it appears a parallel bus, skew which is a problem in a normal parallel-bus is largely decreased since data transfer is performed for each lane independently.

b. Power Management and Link State

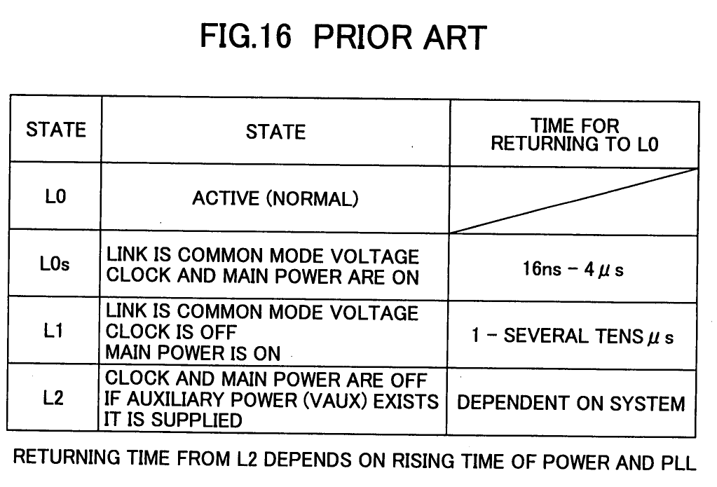

To suppress the consumed power of the link, link states of L0/L0s/L1/L2 are defined as shown in FIG. 16.

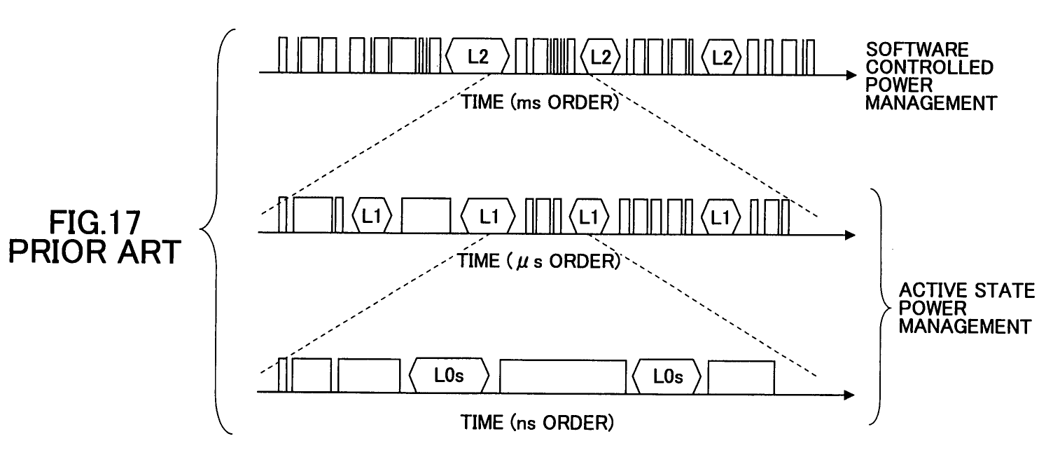

L0 is a normal mode. The consumed power decreases from L0s to L2, but return to L0 takes more time. As shown in FIG. 17, in addition to power management by software, by positively performing active state power management, the consumed power can be decreased as much as possible.

D. Physical Layer—Electronic Sub-Block 157

The main function of the electronic sub-block 157 of the physical layer 155 is to transmit data serialized by the logical sub-block 156 over a lane, receive data from the lane and pass the data to the logical block 156.

a. AC Coupling

In the sending side of a link, a condenser for AC coupling is implemented. Accordingly, it becomes unnecessary that DC common mode voltages are the same between the sending side and the receiving side. Accordingly, it becomes possible to adopt different designs, different semiconductor processes and different power voltage between the sending side and the receiving side.

b. De-Emphasis

As mentioned before, the PCI Express processes data by using the 8B/10B encoding such that consecutive “0” or “1” does not continue as much as possible. However, there may be a case consecutive “0” or “1” appears (five times at the maximum). In such a case, the PCI Express defines that the sending side must perform de-emphasis transfer. When bits of the same polarity continues, it is necessary to increase a noise margin in a received signal in the receiving side by decreasing a differential voltage level (amplitude) by 3.5±0.5 dB from the second bit. This is called the de-emphasis. As to changing bits, many high-frequency components exist due to frequency dependence attenuation and waves in the receiving side become small in the receiving side due to the attenuation. But, as to the unchanging bits, since there are few high-frequency components, waves of the receiving side become relatively large. Therefore, the de-emphasis is performed for keeping the wave form in the receiving side constant.

In the following, embodiments of the present invention are described. In figures for describing each embodiment, reference numerals are assigned independently for each embodiment.

### First Embodiment

A first embodiment of the present invention is described first.

[Data Transfer System, Image Forming System]

The data transfer system of the present embodiment uses the before-mentioned PCI Express system, in which especially the tree structure is expanded and improved.

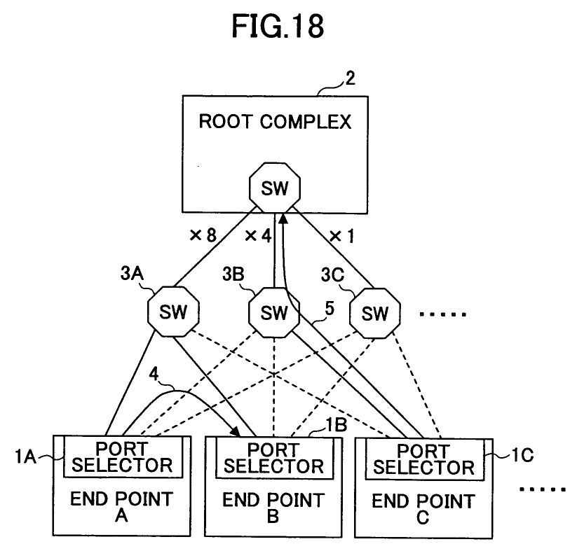

FIG. 18 shows a principle schematic diagram of an example of the tree structure of the data transfer system of the present embodiment. According to the specification of the before-mentioned PCI Express system, the upper port of the end point is only one. But, according to the present embodiment, each of end points A, B, C, . . . has plural upper ports, and each of the end points A, B, C, . . . has a port selector (port selection part) (1A,1B,1C, . . . ) for selecting an upper port to be used according to an operation mode of the data transfer system.

Therefore, in the tree structure of the data transfer system of the present embodiment, a root complex 2 for managing the whole structure exists as an apex, and plural end points A, B, C, . . . are connected to the root complex 2 via plural switches 3A, 3B and 3C. In addition, since each of the end points A, B and C has plural upper ports, the end point A has data transfer routes connected to the switches 3A, 3B and 3C, the end point B has data transfer routes connected to the switches 3A, 3B and 3C, and the end point C has data transfer routes connected to the switches 3A, 3B and 3C. From the viewpoint of the switch, the switch 3A has data transfer routes connected to the end points A, B and C, the switch 3B has data transfer routes connected to the end points A, B and C, and the switch 3C has data transfer routes connected to the end points A, B and C.

In addition, in the present embodiment, different data transfer widths are used for each of the switches 3A,3B and 3C such that data transfer of appropriate data width can be selected according to types of data. Thus, for example, as to the switch 3A, the ×8 link for large amount data transfer is used for the upper side (root complex side) and for the lower side (end point side). As to the switch 3B, the ×4 link is used for the upper side and for the lower side, and as to the switch 3C, the ×1 link is used for the upper side and for the lower side. Of course, if there is no problem as to the cost, ×8 can be used for every bus width, for example.

In this configuration, in an operation mode for processing plural independent data transfers in parallel in the data transfer system, the port selector 1 selects an upper port to be used such that contention does not occur in a data transfer route that passes through the switch 3. For example, in a case when large amount data transfer is required between the end point A and the end point B, and at the same time, data transfer is required between the root complex and the end point 3C, each of the port selectors 1A and 1B selects an upper port of the end points A and B such that the route of the ×8 link for the switch 3A becomes effective as shown in the figure as solid lines. In addition to that, the port selector IC selects an upper port of the end point C such that the route of the ×4 link for the switch 3B becomes effective as shown in the figure as a solid line. Accordingly, the route 4 of ×8 is kept between the end points A and B, and a route 5 of ×4 is kept among root complex 2—switch 3B—end point C. Thus, in addition that large data transfer can be performed by the ×8 link between the end points A and B, data transfer that fully uses the ×4 link can be performed between the root complex 2 and the end point C without being hindered by the data transmission between the end points A and B.

As mentioned above, by selecting an upper port according to the operation mode, the tree structure can be dynamically changed. Therefore, even when plural independent data transfers are processed in parallel, contention for data transfer routes can be avoided by keeping independent data transfer routes so that data transfer efficiency can be improved.

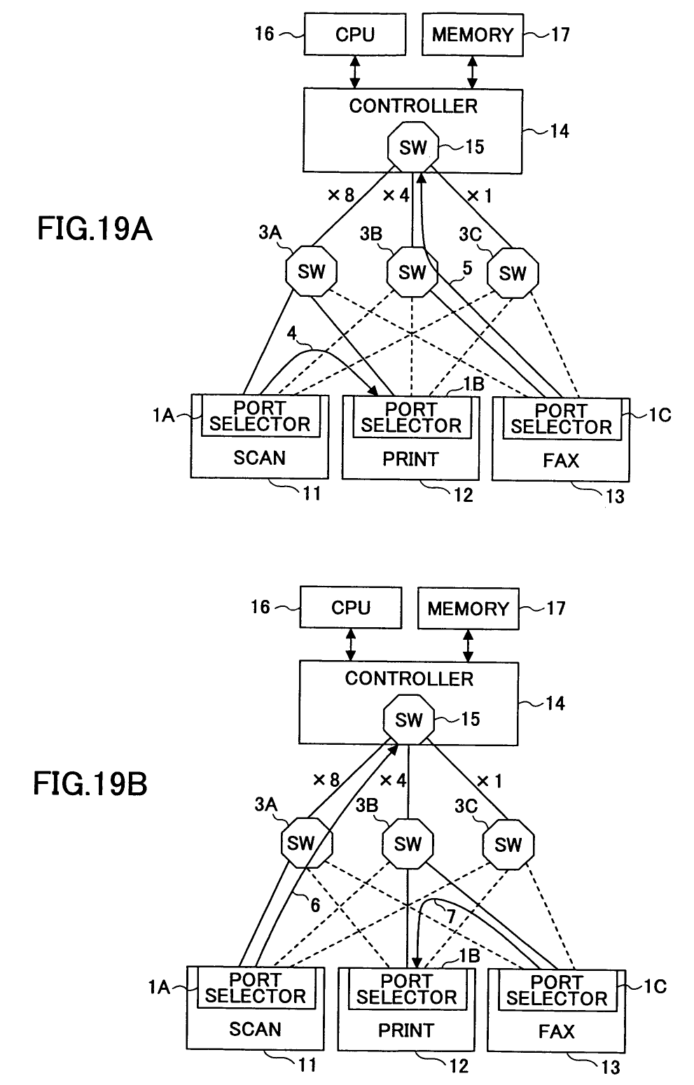

FIGS. 19A and 19B show an image forming system as a preferred example of the data transfer system of the present embodiment. The image forming system is a device for image formation and is configured as a compound machine (also referred to as MFP) that includes a scanner engine part 11 (input part), a printer engine part 12 (output part), and a facsimile part 13 (communication part) each corresponding to each of the end points A, B and C respectively. The reference number 14 indicates a controller that corresponds to the root complex, and that includes a switch 15 corresponding to the switches 3A, 3B and 3C, and a CPU 16 and a memory 17 are connected to the root complex 14 as a computer in the system.

In such a configuration, for example, when a data transfer process for a high-speed copy operation and a data transfer process for receiving facsimile are performed in parallel at the same time, each of the upper port of the scanner engine part 11 and the printer engine part 12 is selected such that ×8 link of the switch 3A becomes effective, and an upper port of the facsimile part 13 is selected such that a ×4 link of the switch 3B becomes effective as shown in FIG. 19A. Thus, by using routes 4 and 5 shown as solid lines in the figure, while high-speed copy is being performed by the route 4 of the ×8 link between the scanner engine part 11 and the printer engine part 12, facsimile received data can be stored in the memory 17 between the facsimile part 13 and the memory 17 via the controller 14 by using the route 5 of the ×4 link.

As another example, in a case when a print operation of facsimile received data and a storing operation (reservation copy) of storing high-speed scanned data into a memory are performed in parallel at the same time, an upper port of the scan engine part 11 is selected such that the ×8 link of the switch 3A becomes effective, and each upper port of the print engine part 12 and the facsimile part 13 is selected such that the ×4 link of the switch 3B becomes effective. Thus, by using the routes 6 and 7 shown as solid lines in the FIG. 19B, while facsimile received data are being printed by the print engine part 12, the high-speed scanned data obtained by the scanner engine part 11 can be transferred to the memory 17 to store the data into the memory as reservation copy.

[Concrete Configuration Example]

In the following, more concrete configuration examples of the end points for realizing the above-mentioned operations are described. In addition, operation examples performed by the CPU 16 as a computer for managing the system are described.

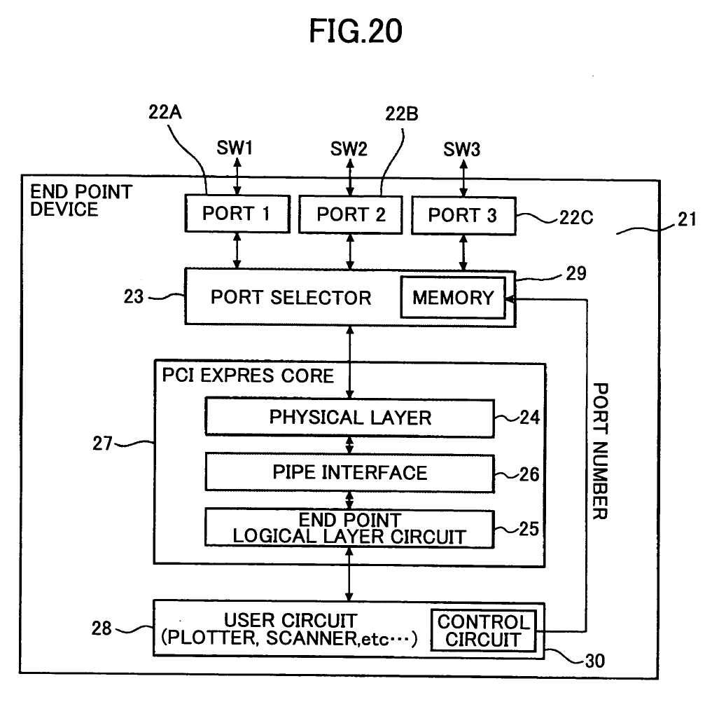

FIG. 20 is a schematic block diagram of a configuration example of an end point 21. As shown in the figure, the end point 21 includes plural ports 22A-22C as plural upper ports each being connected to each of plural switches SW1-SW3 existing in the upper side respectively in an one-to-one relationship. In the lower side of these ports 22A-22C, a port selector 23 is provided as a port selector part. The port selector 23 corresponds to the before-mentioned port selector 1, and switches communication routes from the physical layer 24 so as to connect to one of the ports 22A-22C. In the lower side of the port selector 23, a PCI Express core 27 is provided. The PCI Express core 27 includes the physical layer 24, the end point logical layer circuit 25, and a PIPE interface 26 that connects between the physical layer 24 and the end point logical layer circuit 25 and that conforms to a de-fact standard interface. A user circuit 28 for specifying functions of each end point is connected to the PCI Express core 27 at the lower side. The user circuit 28 receives packets of the PCI Express standard so as to control functions of a corresponding application (scanner, plotter, network card and the like).

The port selector 23 includes a memory 29 for rewritably storing a port number (port selection information) of an upper port to be selected when a link is reset. The memory 29 stores an port number to be selected by the port selector 23 in an initial state. The port selector 23 stores a port number (port selection information) received from an external control circuit 30. In addition, the port selector 23 selects a port corresponding to the port number being stored at the time when a link is reset next. The user circuit 28 includes a control circuit 30. When the user circuit 28 receives a message packet and the message packet includes a port number, the user circuit 28 notifies the control circuit 30 of the message packet. The control circuit 30 outputs the port number of the message packet to the memory 29 such that the memory updates the port number.

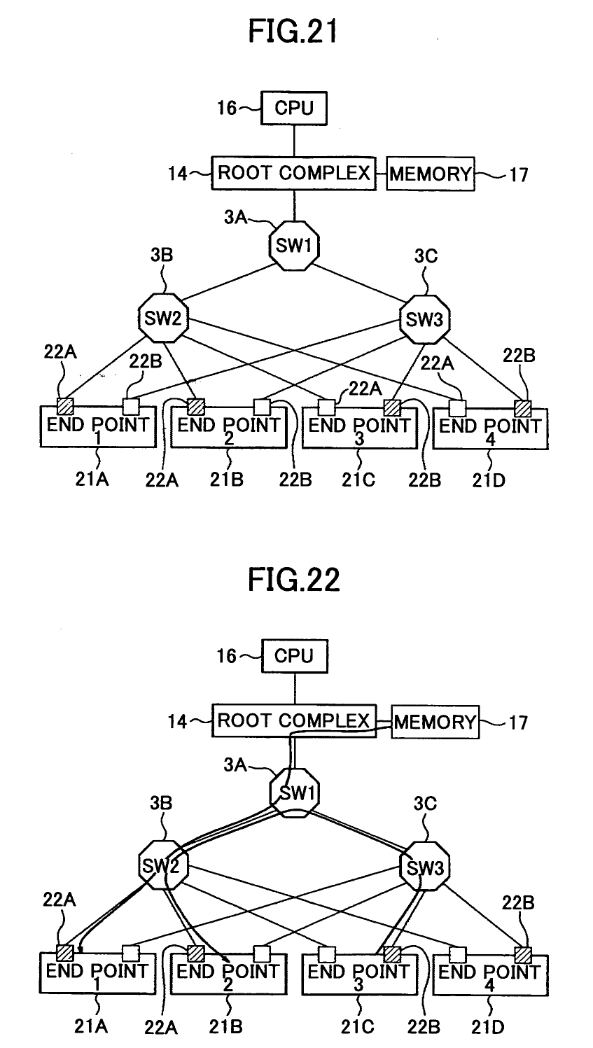

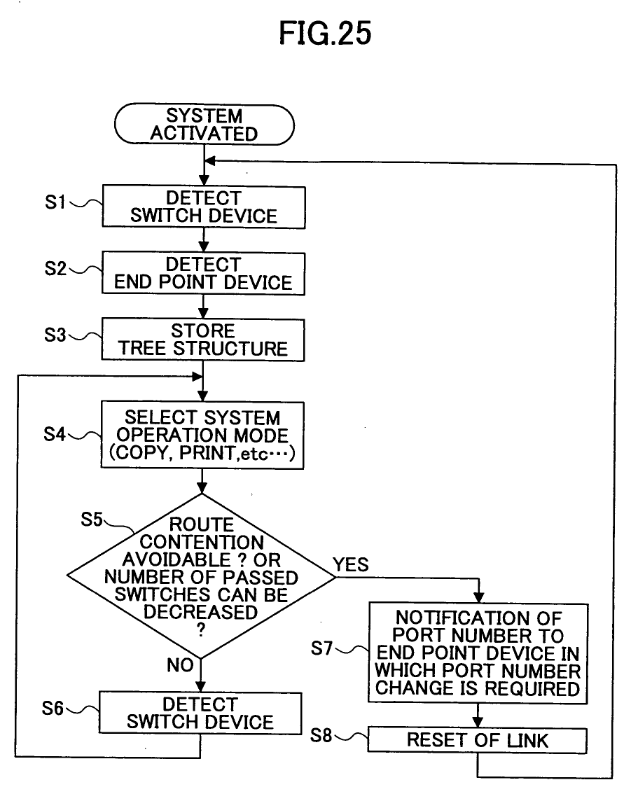

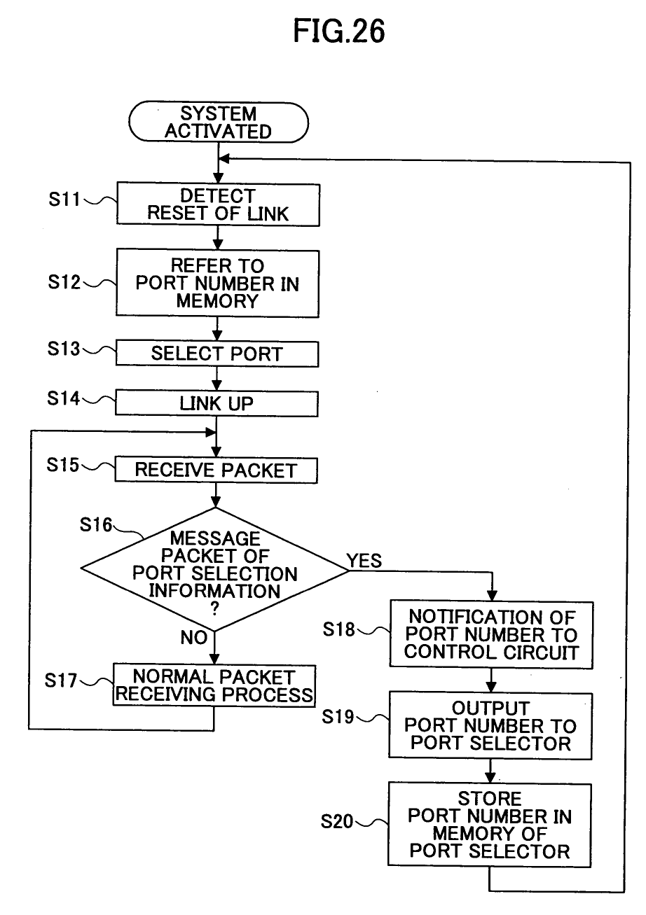

A process procedure for dynamically changing the tree structure of the system is described with reference to FIGS. 21-24 wherein the process procedure is performed by the end point 21 and the CPU 16 that controls the whole system by a program. FIGS. 21-24 are principle schematic diagram showing tree structure examples in different stages. FIG. 25 is a schematic flowchart showing an operation control example performed by the CPU 16. FIG. 26 is a schematic flowchart showing operation examples in each end point (21A-21D). This system of this embodiment includes three switches 3A-3C, four end points 21A-21D each having two ports 22A and 22B. The procedure can be divided to an initialization procedure and a route optimization procedure.

When the system launches, each of the end points 21A-21D performs link-up in a state in which a port designated by a port number stored in the memory 29 in the initial setting is selected by the port selector. That is, as shown in FIG. 26, when the end point detects reset of a link in step S11, the end point refers to the port number stored in the memory 29 in step S12, so that the port selector 23 selects an upper port in step S13 so as to perform link-up in step S14. At the time of the link-up, the CPU 16 searches the switches 3A-3C and the end points 21A-21D existing at the lower side of the controller (root complex) 14 in steps S1 and S2, so as to obtain a tree structure at the initial state and stores the tree structure in a table and the like in the memory 17 in step S3. For each of the switches 3A-3C and the end points 21A-21D, a unique vendor ID and a device ID defined in the standard are assigned, and the IDs are stored in a configuration register (not shown in the figure) defined in the PCI Express standard. The CPU 16 performs configuration read access for the switches 3A-3C and the end points 21A-21D so as to obtain vendor IDs and device IDs and specify device functions and necessary data transfer performance. Information of the vendor ID, device ID, functions and the performance are included in a program beforehand or in the memory 17 connected to the controller (root complex) 14. Such steps S1-S3 are performed as a function of initializing means by the CPU 17.

FIG. 21 is a principle schematic diagram showing an example of a tree structure in a link-up state when the system is activated. That is, in the initial setting, a port number is stored in the memory 29 such that a port 22A is selected in each of the end points 21A and 21B and a port 22B is selected in each of the end points 21C and 21D. The tree structure after completing the link-up and IDs (functions and performance information) are stored in the memory 17.

After the initialization procedure ends, the CPU 16 selects a system operation mode. For example, according to the system operation, the CPU 16 specifies data communication routes by performing calculation processes by a program such that contention for output ports does not occur in-the switches 3A-3C, and determines optimum port numbers, as port selection information, that are to be selected by each port selector 23 in each of the end points 21A-21D. That is, for performing the operation mode of the system, the CPU 16 determines whether contention of the data transfer routes can be avoided or the number of switches through which data pass can be decreased in step S5 while referring to the device functions and necessary data transfer performance specified in the initialization procedure. If neither is possible, data transfer processes are performed as it is since the data transfer routes are already optimized in step S6. If any of the options in step S5 is possible (Y in S5), the CPU 16 determines each upper port optimum for the operation mode for each of the end points 21A-21D, so that the CPU 16 sends a message packet including a port number (port selection information) to a control circuit 30 of an end point in which port change is necessary in step S7. The processes of the steps S4, S5 and S7 are performed as functions of a determination part and a notification part.

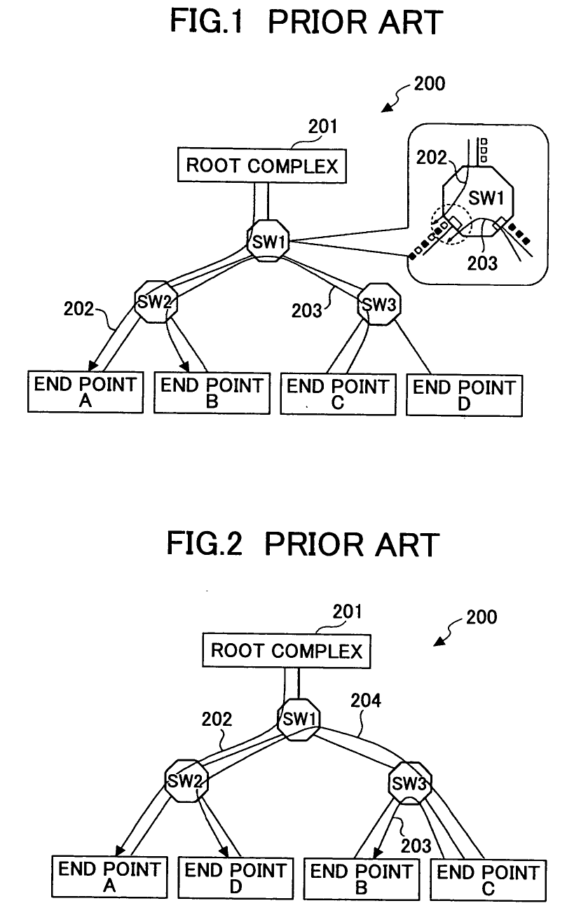

FIG. 22 is a principle schematic diagram showing an operation mode example in which port contention occurs in a switch in the initial setting state. In the operation mode example, data transfer from the end point 21C to the end point 21B is performed while data communication is performed from the memory 17 to the end point 21A. In this case, in the initial setting state, contention occurs at an output port to the switch 3B in the switch 3A (corresponding to a case described with reference to FIG. 1). In this case, for example, the contention can be avoided by changing the port 22B of the end point 21C to the port 22A that is connected to the switch 3B. Thus, in such an operation mode, the CPU 16 determines the port 22A as an optimum upper port of the end point 21C. Then, before actually performing data transfer, the CPU 16 sends a message packet including a port selection information that is “port number=port 22A” to the end point 21C in which the port is to be changed.

At this time, when an end point receives the message packet in step S15, the end point determines that the packet is a message packet including a port number (port selection information) in step S16. If the packet does not include a port number (port selection information) (N in step S16), normal packet receiving processes are performed in step S17. If the packet includes a port number (port selection information) (Y in step S16), the port number (port selection information) is passed to the control circuit 30 in step S18, so that the control circuit 30 sends the information of “port number=port 22A” that is connected to the switch 3B to the port selector in the end point 21C in step S19 so as to update the memory 29 with the information of “port number=port 22A” in step S20.

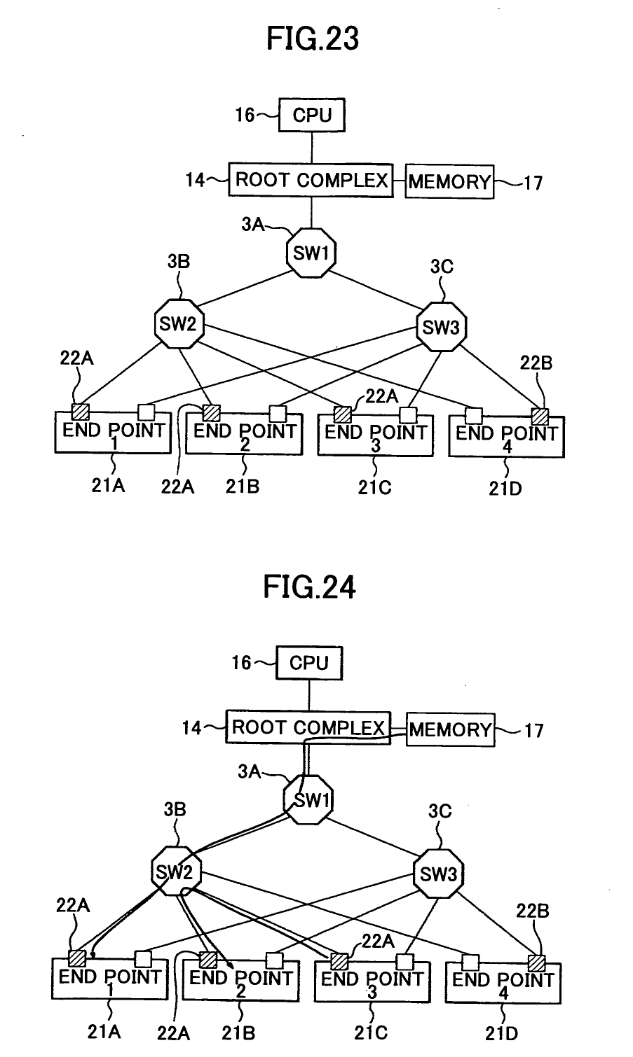

After notification of the port number that needs to be changed in step S7, the CPU 16 resets PCI Express links on the system, and performs re-link-up in a state in which appropriate ports (22A or 22B) are selected in each end point according to the port number (port selection information) in the memory 29 that has been updated in step S8. The process of the step S8 is performed as a function of a re-link-up means. That is, as shown in FIG. 26, when an end point (21A-21D) detects reset of the link in step S1, the port selector selects an upper port (S13) by referring to the port number stored in the memory (S12), so as to perform link-up in step S14. In the case of this example, the link-up is performed in a state in which a port selected in the end point 21C is changed to the port 22A connected to the switch 3B designated by the message packet. FIG. 23 is a principle schematic diagram showing a tree structure example in a state in which re-link-up is completed before actual data transfer.

At the time of such link-up, in the same way as the system activation, the CPU 16 searches the switches 3A-3C and the end-points 21A-21D existing at the lower side of the controller (root complex) 14 in steps S1 and S2, so as to obtain a tree structure at the initial state and stores the tree structure in a table and the like in the memory 17 in step S3. Then, the CPU 16, updates vendor IDs, device IDs and information on functions and performances by performing configuration read access for each device again. After that, actual data transfer is started in step S6.

FIG. 24 is a principle schematic diagram showing an operation mode example under a tree structure after completing re-link-up. According to the configuration example shown in FIG. 24, in the operation example, since contention for any output port of the switch 3A does not occur, data transfer of memory 17—switches 3A, 3B—end point 21A and data transfer of end point 21C—switch 3B—end point 21B can be performed at high-speed.

In the above example, port determination is performed such that the port 22B is changed to the port 22A in the end point 21C. However, alternatively, port determination may be performed such that the port 22A is changed to the port 22B in the end point 21B, so that data transfer is performed in a route of end point 21C—switch 3C—end point 21B.

By the way, in the descriptions with reference to FIGS. 21-24, the CPU 16 determines an upper port to be selected in an end point such that contention for an output port of a switch does not occur. However, the CPU 16 may determine an upper port to be selected in an end point such that the number of switches through which data pass becomes minimum as shown in S5 in FIG. 25.

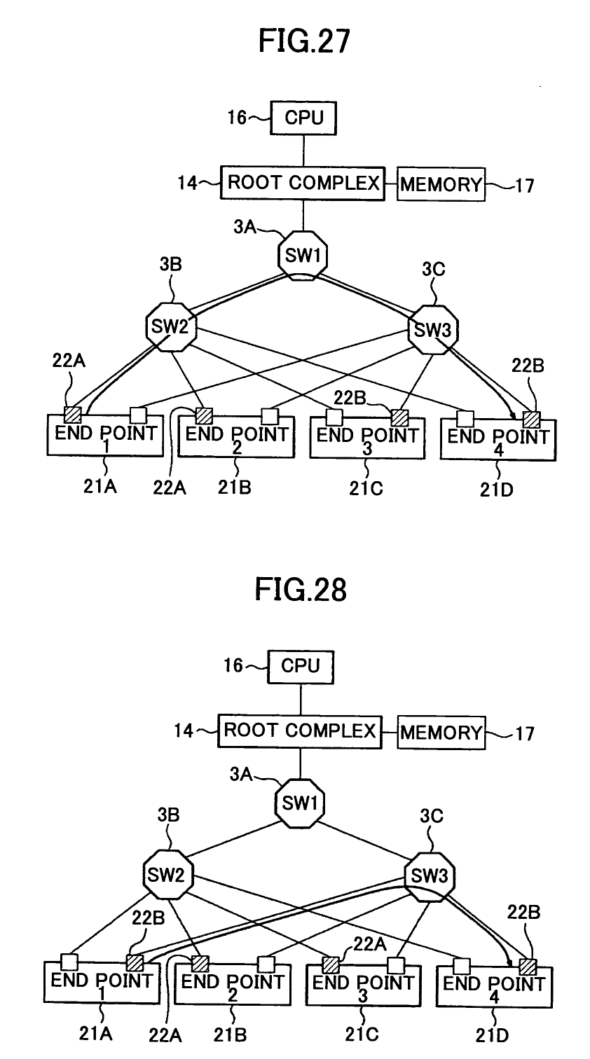

This point is described with reference to FIGS. 27 and 28. FIG. 27, similar to FIG. 21, is a principle schematic diagram showing a tree structure example in a link-up state when the system is activated. In this connection state at the time of the system activation, assuming that data communication is performed from the end point 21A to the end point 21D as an operation mode. In this case, data passes through switch 3B→switch 3A→switch 3C, so that three stages of switches are necessary for the packet transfer. Thus, large delay may occur in this case. In such a case, as shown in FIG. 28, the CPU 16 determines the port 22B instead of the port 22A as an upper side port to be selected in the end point 21A, so that a data transfer route of end point 21A→switch 3C→end point 21D is obtained. That is, data pass through only one stage of switch, that is, the switch 3C. Thus, the delay time necessary for packet transfer can be decreased to one third of the case shown in FIG. 27. Alternatively, also in this case, the determination may be performed such that the port to be selected is the port 22A in the end point 21D.

[Consideration of Effects]

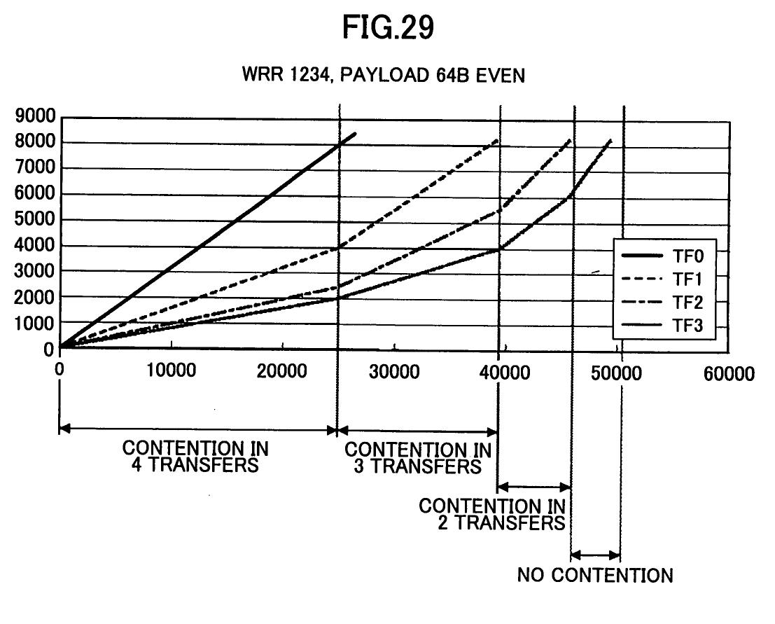

First, effects of output port contention of the switch are considered. When the output port contention occurs in a PCI Express switch, a data transfer rate decreases. FIG. 29 is a graph showing characteristics in a case where four different types of traffics are started at the same time and each traffic is completed in an order of a transmission speed under a condition that contention occurs at one output port for four input ports in a PCI Express switch. In the figure, a lateral axis shows a data transfer time and a vertical axis shows data transfer amounts (accumulated values) in each port, and a slope of each graph indicates the transfer rate. In the graphs, the payload sizes are the same for the four types of traffics, namely 64 bytes fixes, wherein the payload size means a size of a data part other than header information in the whole data packet. The algorithm of the data transfer is the weighted round robin (WRR) in the PCI Express standard, in which the ratio of the weight is 1:2:4:8 for the four types of traffics respectively, and, the ratio is changed such that, after data transfer ends for one traffic class, the ratio becomes 8:4:2 for remaining traffic classes, and further the ratio becomes 8:4.

In FIG. 29, it can be recognized that, from the left side, contention occurs in four transfers, contention occurs in three transfers, contention occurs in two transfers, and there is no contention. As the number of traffics in which contention occurs decreases, it can be recognized that the slope (transfer rate) becomes steeper so that the data transfer rate improves. Relating to this point, according to the present embodiment mentioned before, since a port to be selected is determined such that contention for an output port in a switch does not occur as to the upper ports of the end points 21A-21D, the data transfer rate can be improved.

Next, effects of the number of stages through which data pass are considered. When data are transferred by dividing the data by a predetermined amount, effects of initial delay for the packet data to arrive a destination from a source increase as the number of switch stages through which the data pass increases, wherein this case corresponds to a case where image data are divided line-by-line for each main scanning direction so as to be sent to a plotter in an image forming system, for example.

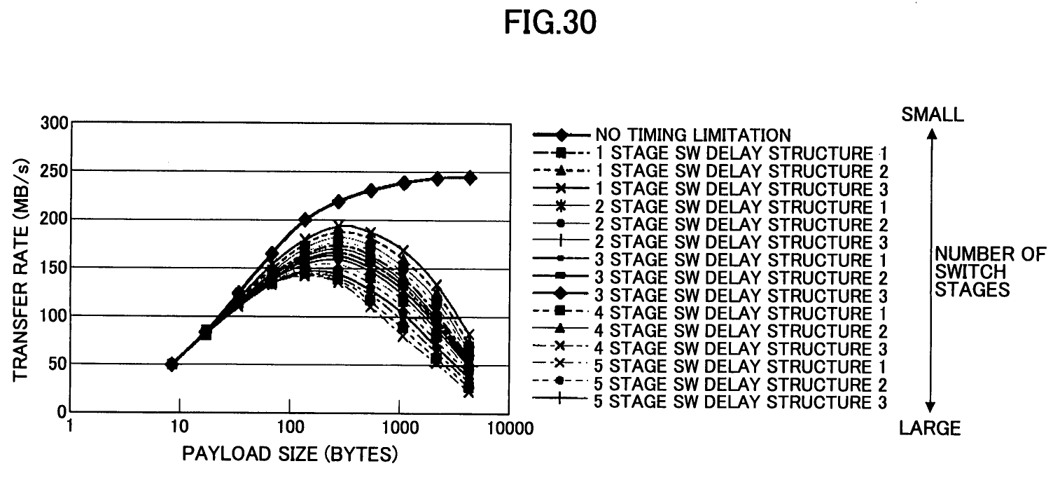

FIG. 30 is a graph showing relationships between payload sizes and transfer rates in which the number of switches through which data pass is used as a parameter. FIG. 30 shows effects of the number of switches to the transfer rate. In the figure, from the upper side, cases are shown, which are no timing limitation, one stage of switch and delay structures 1, 2 and 3, two stages of switches and delay structures 1, 2 and 3, three stages of switches and delay structures 1, 2 and 3, four stages of switches and delay structures 1, 2 and 3, and five stages of switches and delay structures 1, 2 and 3. As the number of the stages increases one by one, the delay time of the packet transfer is increased, and the larger the size of the packet data is, the larger the delay occurs. Therefore, when plural stages of switches exist on a data transfer route, the larger the size of data in a packet is, the lower the data transfer rate becomes. At this point, according to the before mentioned present embodiment, since a port is determined such that the number of stages of the switches becomes minimum as to the upper ports in the end points 21A-21D, it can be recognized that the deterioration of the data transfer rate can be suppressed.

### Second Embodiment

In the following, a second embodiment of the present invention is described.

[Data Transfer System, Image Forming System]

The data transfer system of the present embodiment uses the before-mentioned PCI Express system, in which especially the tree structure is expanded and improved.

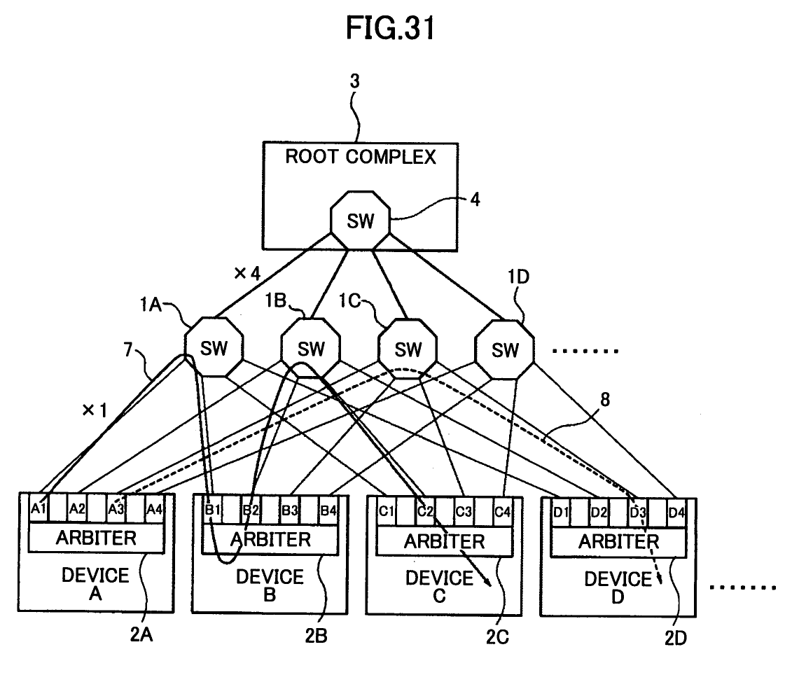

FIG. 31 shows a principle schematic diagram of an example of the tree structure of the data transfer system of the present embodiment. According to the specification of the before-mentioned PCI Express system, each of devices that exists in the lower side (end side) of the tree structure includes one end point. On the other hand, according to the present embodiment, plural end points (A1, A2, . . . , A4, B1, . . . , B4, C1, . . . , C4, D1, . . . , D4, . . . ) are assigned to each of the devices A, B, C, D, . . . , so that each end point is connected to a lower side port of a corresponding upper side switch. In addition, arbiters 2A, 2B, 2C, 2D, . . . are provided in corresponding devices A, B, C, D, . . . , wherein the arbiter is for arbitrating end points to be used according to an operation mode of the image forming apparatus.

Therefore, the image forming system of the present embodiment forms a tree structure in which a root complex 3 for managing the whole system is provided as an apex, and the plural devices A, B, C, D, . . . at the lower side are connected to the root complex 3 via a switch 4 existing at the top and included in the root complex 3, and plural switches 1A, 1B, 1C, 1D, . . . existing at the middle. Since each device has plural end points, the device A has four data transfer routes each connecting an end point (A1, A1, A2, A3 or A4) to a lower side port of a corresponding switch (1A, 1B, 1C or 1D), for example. In the same way, the device B has four data transfer routes each connecting an end point (B1, B2, B3 or B4) to a lower side port of a corresponding switch (1A, 1B, 1C or 1D), the device C has four data transfer routes each connecting an end point (C1, C2, C3 or C4) to a lower side port of a corresponding switch (1A, 1B, 1C or 1D), and the device D has four data transfer routes each connecting an end point (D1, D2, D3 or D4) to a lower side port of a corresponding switch (1A, 1B, 1C or 1D).

Each of data transfer widths between the switch 4 and the switches 1A˜1D is the ×4 link width, and each of data transfer width between the switches 1A˜1D and the devices A˜D is the ×1 link width.

In such a configuration, when an operation mode is adopted in which plural independent data transfers are processed in parallel in the data transfer system, each of the arbiters 2A˜2D in each of the devices A˜D arbitrates end points to be used such that contention for a data transfer route passing through the switch 1 does not occur.

For example, in a case where a data transfer process for processing image data from the device A and transferring the image data to the device C is performed with a data transfer process for outputting image data from the device A to the device D in parallel, the arbiter 2A in the device A determines to use the end point A1 for the switch 1A and use the end point A3 for the switch 1c, the arbiter 2B in the device B determines to use the end points B1 and B2 for the switches 1A and 1B, the arbiter 2C in the device C determines to use the end point C2 for the switch 1B and the arbiter 2D in the device D determines to use the end point D3 for the switch 1C.

Accordingly, a ×1 link route 7 of device A (end point A1)—switch 1A—device B (end points B1 and B2)—switch 1B—device C (end point C2), and a ×1 link route 8 of device A (end point A3)—switch 1C—device D (end point D3) are established.

By arbitrating between end points for each of the devices A-D according to the operation mode, the tree structure can be dynamically changed. Thus, even when plural independent data transfers are processed in parallel, contention for a data transfer route can be avoided by keeping independent data transfer routes so that data transfer efficiency can be improved.

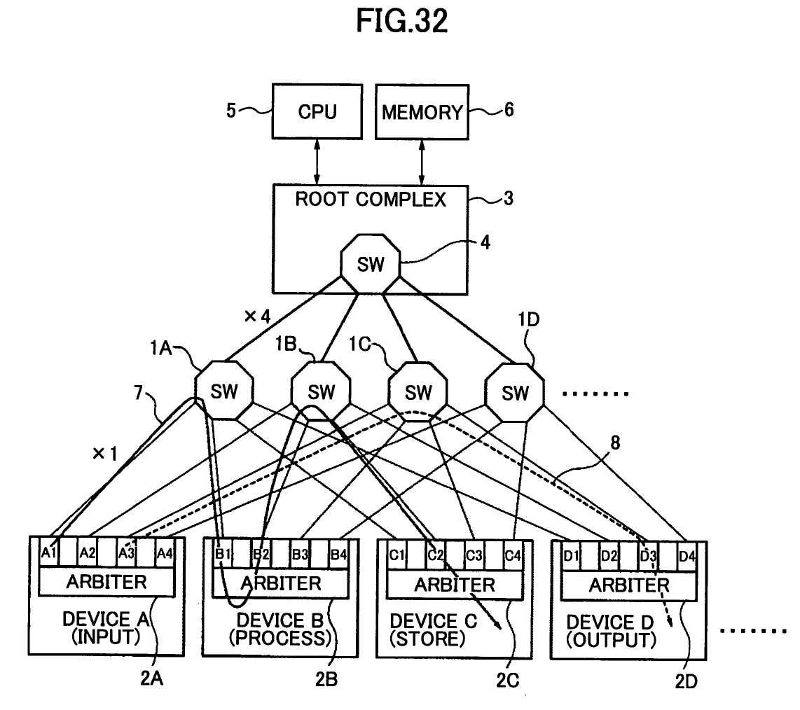

FIG. 32 shows an image forming system that is a preferred example of a data transfer system of the present embodiment. The image forming system includes devices A, B, C and D, for example. The device A is an image input device such as a scanner engine for performing photoelectric conversion on a document image to read the image. The device B is an image process device for performing various image processing on image data such as scaling and rotation. The device C is a storage device such as a memory and a HDD for storing image data. The device D is an image output device such as a printer engine for printing image data on a paper. The root complex 3 is configured as a controller in the image forming system, and is connected to a CPU 5 and a memory 6.

For example, in a case where a data transfer process for performing image processing on image data read by the device A in the device B and transferring the image data to the device C is performed with a data transfer process for outputting image data read by the device A to the device D to print the image data in parallel, the arbiter 2A in the device A determines to use the end point A1 for the switch 1A and use the end point A3 for the switch 1C, the arbiter 2B in the device B determines to use the end points B1 and B2 for the switches 1A and 1B, the arbiter 2C in the device C determines to use the end point C2 for the switch 1B and the arbiter 2D in the device D determines to use the end point D3 for the switch 1C.

Accordingly, a ×1 link route 7 of device A (end point A1)—switch 1A—device B (end points B1 and B2)—switch 1B—device C (end point C2), and a ×1 link route 8 of device A (end point A3)—switch 1C—device D (end point D3) are established. Accordingly, data transfer from image processing to memory storing for the read image data can be performed by the ×1 link among the devices A, B and C, and at the same time, data transfer for copying can be performed between the devices A and B by fully using the ×1 link without being hindered by data transfer among the devices A, B and C.

By arbitrating between end points for each of the devices A-D according to the operation mode, the tree structure can be dynamically changed. Thus, even when plural independent data transfers are processed in parallel, contention for a data transfer route can be avoided by keeping independent data transfer routes so that data transfer efficiency can be improved.

[Management of route Information]

By the way, the arbitration for end points by the arbiter of the device can be executed by referring to route information written in the device, wherein “arbitration” means determination of an end point to be used for accessing another device. The setting of the route information is mainly executed according to a data transfer program installed in the CPU 5.

In the following, an example of a management method for the route information is described. In this example, it is assumed that each device (A-D) not only stores information on its device functions but also stores information on end points in its memory area such that the stored information are accessible from CPU 5, wherein the information on the end points includes the number of end points (four in the example of the figure), the number of lanes for each end point (×1 in the example of the figure), connection destinations (a lower port of switch 1A for the end point A1, for example).

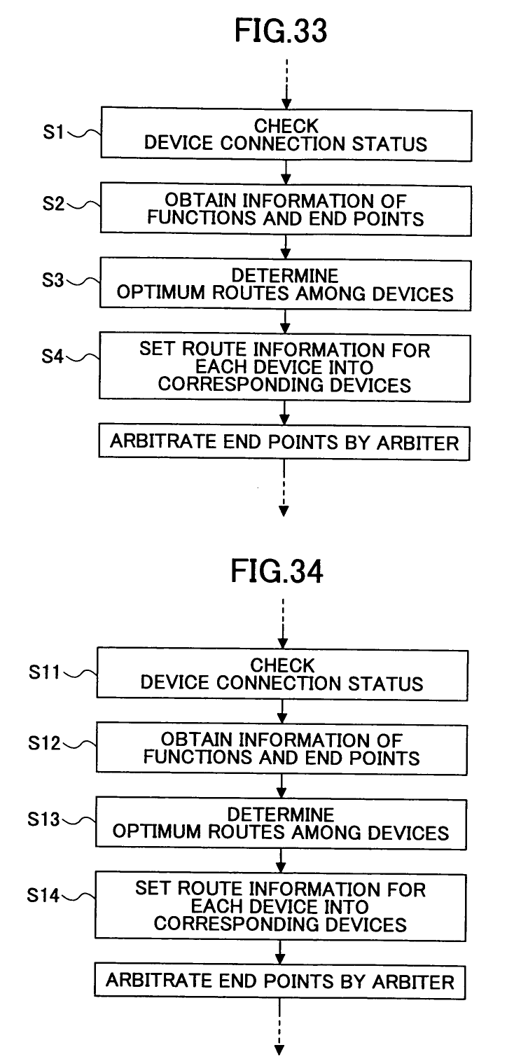

Under this condition, the host CPU 5 performs process control according to a data transfer program, namely, a flowchart shown in FIG. 33. The host CPU 5 includes, as its functions, a determination part and a setting part. The determination part determines an optimum route between devices in the tree structure based on device connection status in the system, information on each device function, and information on end points obtained from each device. The setting part writes the route information determined for each device in the device. The arbiter in each device refers to the route information set by the setting part to determine an end point to be used for accessing another device.

As shown in FIG. 33, the host CPU 5 checks connection status of the devices A˜D in the data transfer system (image forming system) in step S1. In addition to that, the CPU 5 accesses each connected device to obtain information of the function of the device and information on end points of the device in step S2. In addition, the CPU 5 obtains information on an operation mode to be performed, so that the CPU 5 determines an optimum route among the devices A˜D in the tree structure in step S3. To determine an optimum route among the devices means to select switches such that conflict between plural routes does not occur. For example, each of the routes 7 and 8 shown in FIG. 31 is the optimum route.

The route information for each device is written and set in a corresponding device in step S4.

After that, the determination of end points in each device is performed by the corresponding arbiter by referring to the route information written by the CPU 5. For example, the arbiter 2A determines to use the end points A1 and A3.

In the following, another example of the management method of the route information is described. In this example, it is assumed that the host CPU 5 directly manages not only information on its device functions but also information on end points for each device, wherein the information on the end points includes the number of end points (four in the example of the figure), the number of lanes for each end point (×1 in the example of the figure), connection destinations (a lower port of switch 1A for the end point A1, for example).

The host CPU 5 includes, as its functions, an information management part, a determination part and a setting part. The information management part manages information on device functions of each device and information on end points. The determination part determines an optimum route between devices in the tree structure based on device connection status in the system, information on each device function information on end points that are managed by the information management part. The setting part writes the route information determined for each device in the device. The arbiter in each device refers to the route information set by the setting part to determine an end point to be used for accessing another device.

Under this condition, the host CPU 5 performs process control according to a data transfer program, namely, a flowchart shown in FIG. 34. As shown in FIG. 34, the host CPU 5 checks connection status of the devices A˜D in the data transfer system (image forming system) in step S11. In addition to that, the CPU 5 obtains information of the functions of the devices A˜D and information on end points of the devices in step S12. In addition, the CPU 5 obtains information on an operation mode to be performed, so that the CPU 5 determines an optimum route among the devices A˜D in the tree structure in step S13. The route information for each device is written in a corresponding device in step S14.

After that, the determination of end points in each device is performed by the corresponding arbiter by referring to the route information written by the CPU 5. For example, the arbiter 2A determines to use the end points A1 and A3.

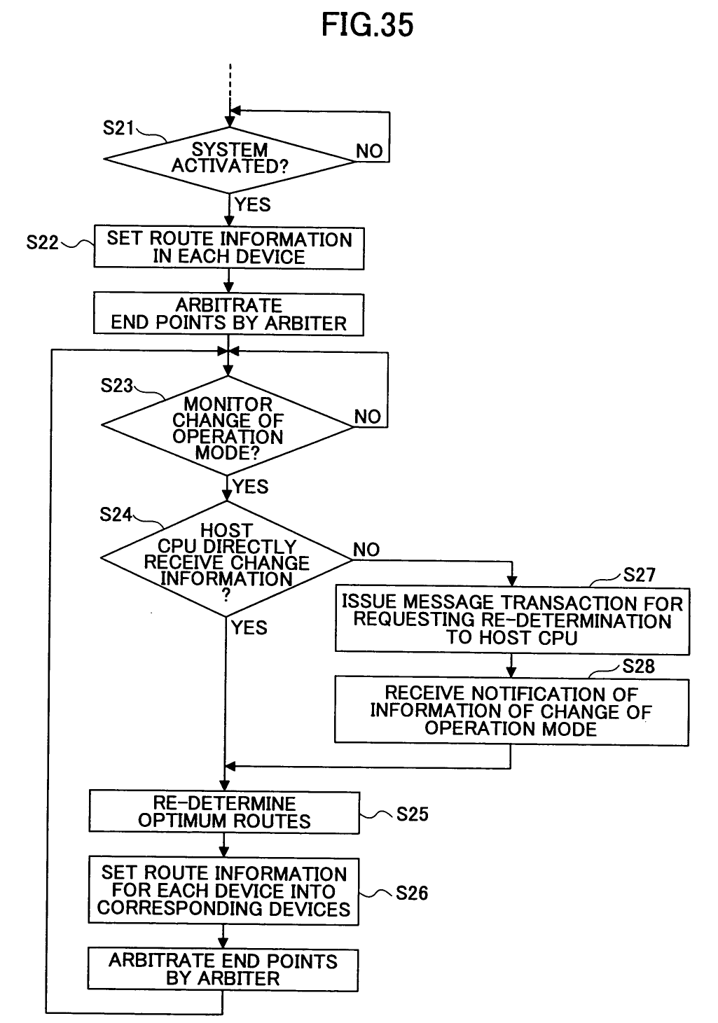

Next, an example of timing control in the management method of the route information is described with reference to a schematic flowchart shown in FIG. 35. When the system is activated (Y in step S21), route information are written and set in each of the devices A˜D in step S22. The “when the system is activated” includes a time period until some time period elapses from the time of the activation, and it is not limited to a time point at which the system is activated. The route information set in step S22 are predetermined default values in the standard specification.

After that, the determination of end points in each device is performed by a corresponding arbiter by referring to the route information (default value) written by the CPU 5 in the device.

After that, presence or absence of a change of the operation mode is monitored in the activated system in step S23. When there is a change of the operation mode (Y in step S23), and when the host CPU 5 directly receives information on the change of the operation mode (Y in step S24), the host CPU 5 re-determines optimum route information among the devices A˜D in the tree structure based on the changed operation mode, device connection status, device function information and information on the end points that are obtained from each device or managed by the host CPU 5 in step S25. The route information for each device determined in step S25 are written and set in corresponding devices A˜D in step S26.

After that, the determination of end points in each device is performed by a corresponding arbiter by referring to the route information written by the CPU 5 in the device.

On the other hand, when one of the devices A˜D receives the information of the change (N in step S24), the device issues a message transaction to the host CPU 5 for requesting the host CPU 5 to re-determine route information in step S27. The host CPU 5 obtains information on the change of the operation mode stored in the message transaction packet in step S28. After receiving the information on the operation mode, processes after the step S25 are performed in the same way.

Instead of the process of the step S28, the CPU 5 may obtain the information of the change of the operation mode by referring to the information that is held by the device that transmitted the message transaction packet in response to receiving the message transaction packet.

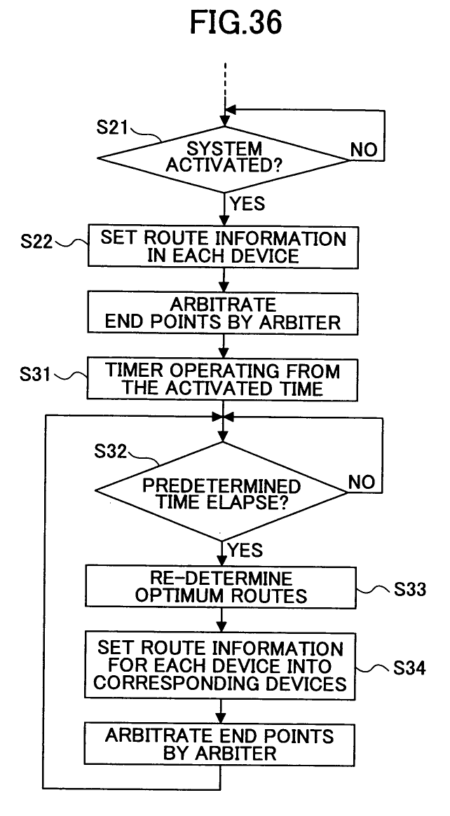

Next, another example of timing control in the management method of the route information is described with reference to a schematic flowchart shown in FIG. 36. In the same way as described in FIG. 34, when the system is activated (Y in step S21), route information are written and set in each of the devices A˜D in step S22.

After that, the determination of end points in each device is performed by a corresponding arbiter by referring to the route information (default values) written by the CPU 5 in the device.

After that, a timer is started from the time when the system is activated in step S31, and it is monitored whether a predetermined time elapses in step S32. At each time when the predetermined time elapses, namely, periodically (Y in step S32), the host CPU 5 re-determines optimum route information among the devices A˜D in the tree structure based on the operation mode at the time, device connection status, device function information and information on the end points that are obtained from each device or managed by the host CPU 5 in step S33. The route information for each device determined in step S33 are written and set in corresponding devices A˜D in step S34.

After that, the determination of end points in each device is performed by a corresponding arbiter by referring to the route information written by the CPU 5 in the device.

As to the effects of the present embodiment, in the same way as the first embodiment described with reference to FIGS. 29 and 30, since an end point is determined in each device such that contention does not occur, the data transfer rate can be improved. In addition, according to the present embodiment, since the end points are determined such that the number of switches becomes minimum, the deterioration of the data transfer rate can be reduced.

### Third Embodiment

In the following, third embodiment of the present invention is described.

[Image System]

The image system of the present embodiment uses the before-mentioned PCI Express system, in which especially the tree structure is improved.

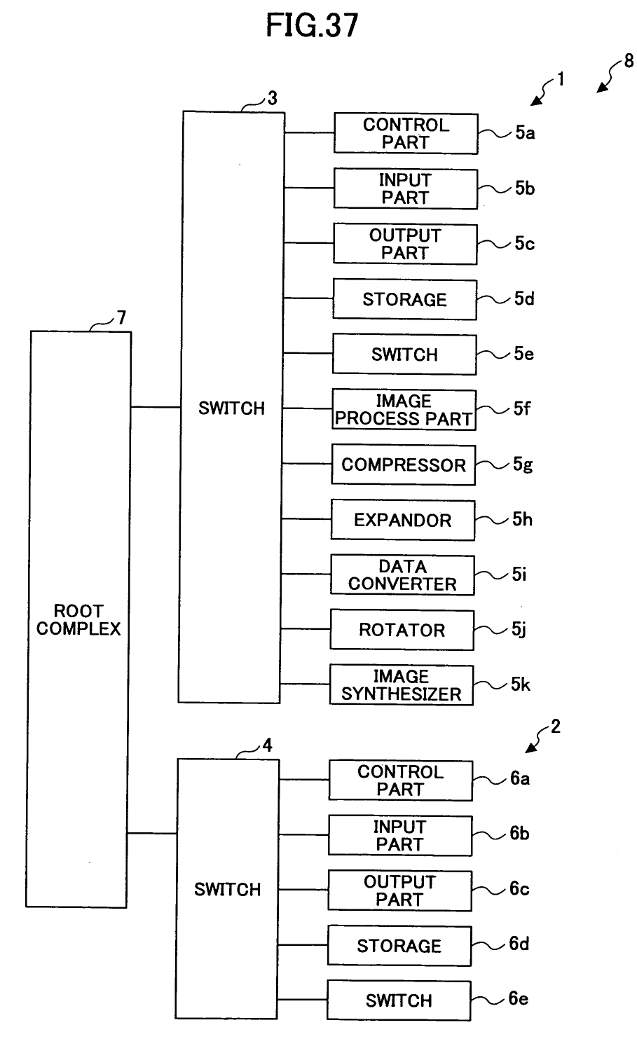

FIG. 37 shows a principle schematic diagram of an example of the tree structure of the image system of the present embodiment. The present embodiment includes image apparatuses 1 and 2 having different structures (performance). The image system has a tree structure in which switches 3 and 4 in the PCI Express system exist at the top, and plural devices included in the image apparatuses 1 and 2 exist at end point positions and are connected to the switches 3 and 4. The image apparatus 1 is a high-speed image apparatus, for example. The image apparatus 1 includes a control part 5a, an input part 5b, an output part 5c, a storage 5d, a switch 5e, an image process part 5f, a compressor 5g, an expandor 5h, a data converter 5i, a rotator 5j, an image synthesizer 5k and the like. Each of the devices are connected to the switch 3 by a required 10 number of lanes (ports). The image apparatus 2 is a low-speed image apparatus, for example. The image apparatus 2 includes a control part 6a, an input part 6b, an output part 6c, a storage 6d, a switch 6e and the like. Each of the devices is connected to the switch 4 by a required number of lanes (ports).

In the devices, the input part is a scanner engine, for example, for reading a document image by a CCD and converting the image to an electronic signal. The output part is a printer engine, for example, for printing data on a recording medium such as paper based on image data and the like. The storage is a memory or a HDD for temporarily storing image data or storing image data or jam backup. The compressor is for compressing data, and the expandor is for expanding data. A compressor-compressor having both functions can be used. The rotator is for rotating the image data by 90°, 180° or 270°. For example, the rotator is used when two A4 documents are integrated and printed to a A4 size paper, or when an image to be printed is adjusted to a direction of a paper in a tray. The data converter is a part for performing a process for executing a printer language, for example. The image synthesizer is a part for performing a process for synthesizing image data and print data into synthesized data, for example.

The image system 8 is configured by connecting the top switches 3 and 4 that configure the image apparatuses 1 and 2 respectively to a common root complex 7 existing at an upper position (root side).

According to such a configuration, by adopting the PCI Express system that is a high-speed serial bus, speed of data transfer can be increased basically. In addition to that, speed of data transfer in each of the image apparatus 1 and 2 can be increased more. That is, since the PCI Express system in each of the image apparatuses 1 and 3 forms a tree structure having the switch (3 or 4) at the top without using the root complex, data transfer among devices 5a-5k and among 6a-6e are performed without using the root complex, so that high-speed processing becomes possible.

In addition, when considering the whole image apparatus system 8, a high-performance system can be realized at low cost. That is, if all of the functions are provided only by the image apparatus 1, high-cost would be required. On the other hand, according to the system shown in the figure, the cost can be reduced since the system can be established by distributing the functions to the image apparatuses 1 and 2. In this case, when the image apparatus 2 requires a high-performance function, since data passes through the root complex, the speed is decreased compared with when single image apparatus is used. However, there is a merit in that the image apparatus 2 can easily use resources of the image apparatus 1 by providing the root complex 7.

In the above-mentioned example, as to the image apparatuses 1 and 2 having different functions, the image apparatus 1 is a high-speed image apparatus and the image apparatus 2 is a low-speed image apparatus. But, the present embodiment is not limited to such an example. Various combinations can be applied in the same way. For example, the image apparatus 1 may be a color image apparatus and the image apparatus 2 may be a black and white image apparatus. In addition, a laser printer function may be provided in the image apparatus 1 and an inkjet printer may be provided in the image apparatus 2. Further, the image apparatus 1 may support a wide-width paper such as A2 and the image apparatus 2 may support A3. Devices connected to the lower side of the switches 3 and 4 are determined according to the configuration of each of the image apparatuses.

The number of switches (the number of image apparatuses) is not limited to two. It may be equal to or greater than three.

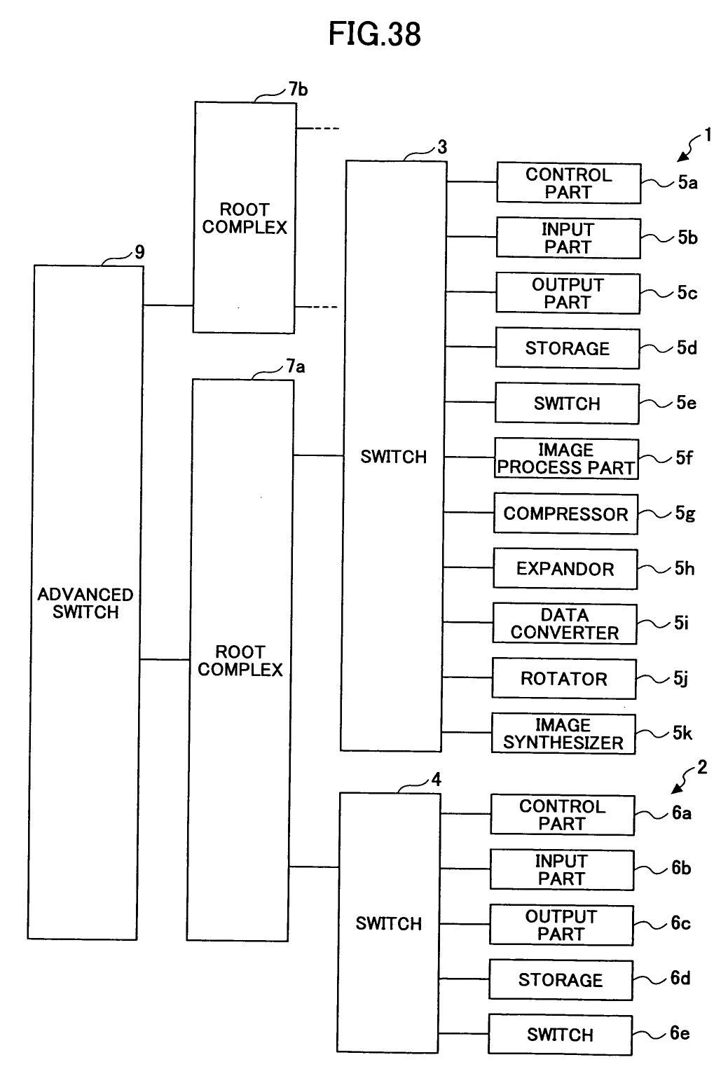

FIG. 38 shows an expanded example. In the configuration shown in FIG. 38, plural root complexes 7a and 7b are provided and the root complexes are connected to a common advanced switch 9. That is, by connecting the root complexes 7a and 7b with each other by the advanced switch 9, more image apparatus systems can be used commonly, so that this system is applicable for various image forming processes.

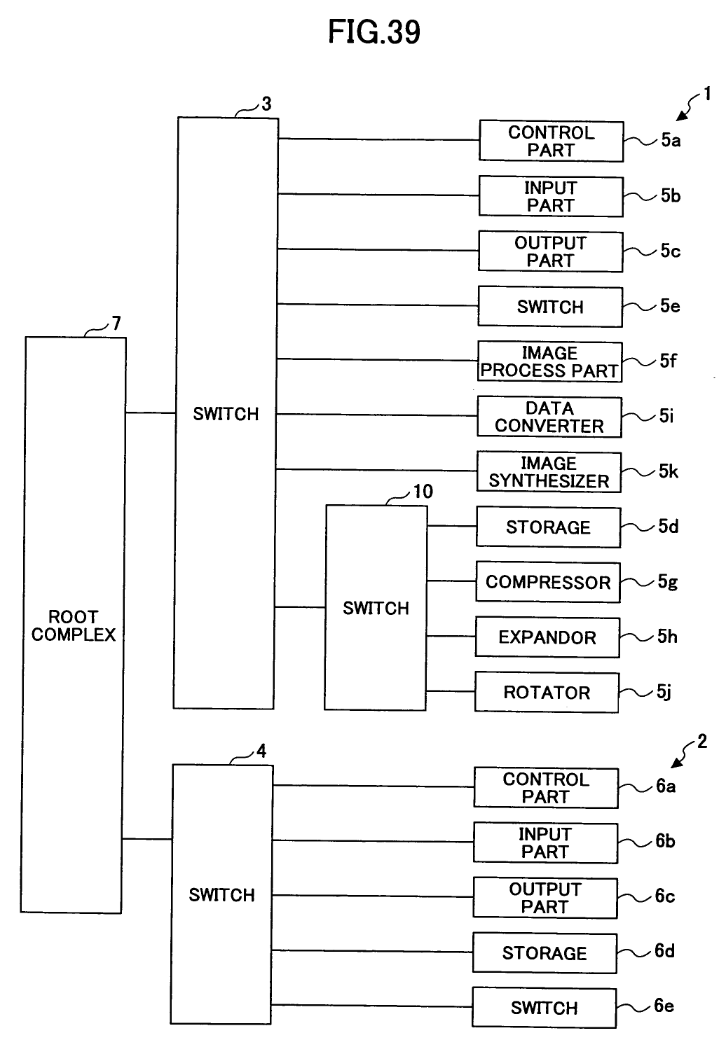

FIG. 39 shows a modified example of the image apparatus system of the present embodiment. In this example, devices having strong correlation in the devices of the image apparatus 1 are not directly connected to the switch 3, but are connected to the switch 3 via a terminal side common switch 10, wherein the devices having strong correlation are the storage 5d, the compressor 5g, the expandor 5h and the rotator 5j in the example shown in FIG. 39. That is, the devices 5d, 5g, 5h and 5j show strong correlation as to image data processing in which compressed image data or rotated image data are once stored in the storage, and are read from the storage to expand the compressed image data.

Since the devices 5d, 5g, 5h and 5j are connected to the switch 3 via the terminal side common switch 10, data are not passed through the switch 3 in data transfer among the devices 5d, 5g, 5h and 5j. Only by passing through the terminal side common switch 10, setting of the data transfer route becomes easy, and the speed of data transfer among the devices 5d, 5g, 5h and 5j is further increased.

The devices having strong correlation shown in FIG. 39 are merely an example, and various examples can be applied. For example, since an output image on a memory is compressed and stored in a HDD for jam backup, the memory, the compressor (or compressor-expandor) and the HDD can be connected to the terminal side common switch as devices having strong correlation.

In addition, since coded data in the HDD are loaded in the memory after being expanded, the HDD, the expandor (or compressor-expandor) and the memory can be connected to the terminal side common switch as the devices having strong correlation. In addition, there are many cases where image data in the memory are rotated to an output direction and are stored in the memory again, the memory and the rotator can be connected to the terminal side common switch as the devices having strong correlation. Further, since there are many cases where image data read by the scanner engine are compressed by the compressor-expandor to be loaded in the memory, the scanner (input part), the compressor-expandor, and the memory can be connected to the terminal side common switch as the devices having strong correlation. In this case, since there are many cases where a scaling process is included, the scaling part can be included as the devices having the strong correlation. In addition, inversely, since there are many cases where coded data in the memory are expanded by the compressor-expandor to be output by the printer, the printer (output part), the compressor-expandor, and the memory can be connected to the terminal side common switch as the devices having strong correlation. In this case, since there are many cases where a scaling process is included, the scaling part can be included as the devices having the strong correlation. Further, since there is a case where image data stored in the memory and print data are synthesized by the synthesizer and the printer outputs the synthesized data, the memory, the synthesizer and the printer (output part) can be connected to the terminal side common switch as the devices having strong correlation. In the same way, since there are many cases where coded data (printer language) in the memory are translated by the data converter to be printed by the printer, the memory, the data converter and the printer (output part) can be connected to the terminal side common switch as the devices having strong correlation.

### Fourth Embodiment

In the following, a fourth embodiment of the present invention is described.

[Image System]

The image system of the present embodiment uses the before-mentioned PCI Express system, in which especially the tree structure is improved.

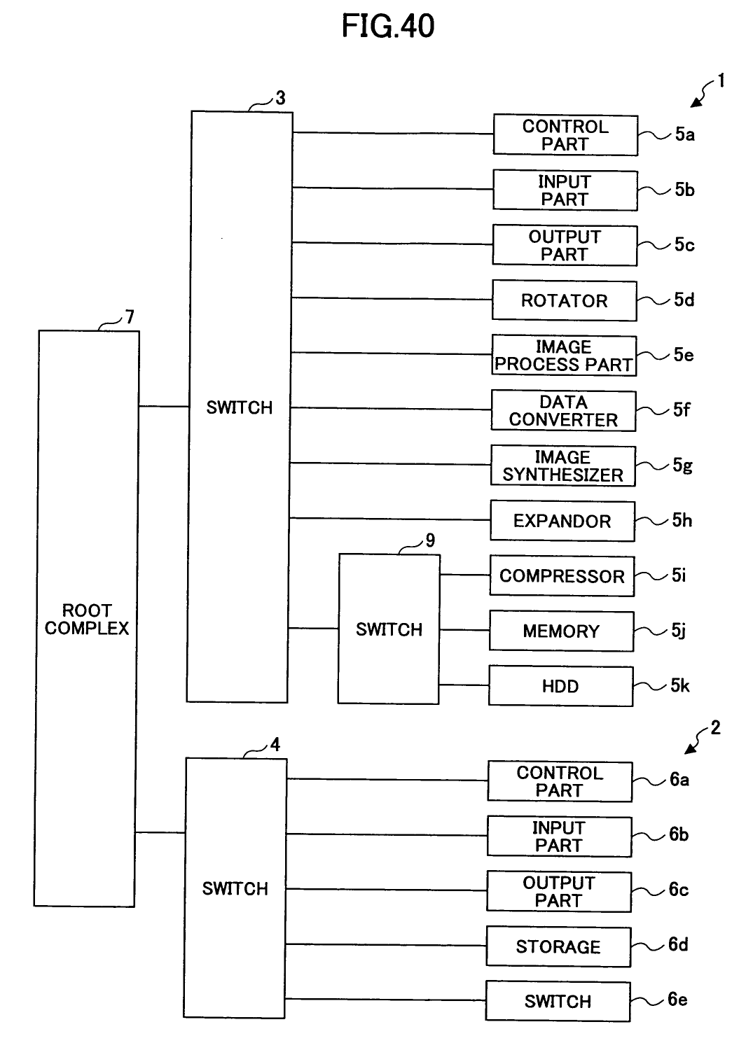

FIG. 40 shows a principle schematic diagram of an example of the tree structure of the image system of the present embodiment. The present embodiment includes image apparatuses 1 and 2 having different structures. The image system has a tree structure in which switches 3 and 4 in the PCI Express system exist at the top, and plural devices included in the image apparatuses 1 and 2 exist at end point positions and are connected to the switches 3 and 4. The image apparatus 1 is a high-speed image apparatus, for example. The image apparatus 1 includes a control part 5a, an input part 5b, an output part 5c, a rotator 5d, an image process part 5e, a data converter 5f, an image synthesizer 5g, an expandor 5h, a compressor 5I, a memory 5j, a HDD 5k and the like. Each of the devices are connected to the switch 3 by a required number of lanes (ports). The image apparatus 2 is a low-speed image apparatus, for example. The image apparatus includes a control part 6a, an input part 6b, an output part 6c, a storage 6d, a switch 6e and the like. Each of the devices is connected to the switch 4 by a required number of lanes (ports).

In the devices, the input part is a scanner engine, for example, for reading a document image by a CCD and converting the image to an electronic signal. The output part is a printer engine, for example, for printing data on a recording medium such as a paper based on image data and the like. The storage is a memory or a HDD for temporarily storing image data or storing image data or jam backup. The compressor is for compressing data, and the expandor is for expanding data. A compressor-compressor having both functions can be used. The rotator is for rotating the image data by 90°, 180° or 270°. For example, the rotator is used when two A4 documents are integrated and printed to a A4 size paper, or when an image to be printed is adjusted to a direction of a paper in a tray. The data converter is a part for performing a process for executing a printer language, for example. The image synthesizer is a part for performing a process for synthesizing image data and print data into synthesized data, for example.

The image system 8 is configured by connecting the top switches 3 and 4 that configure the image apparatuses 1 and 2 to a common root complex 7 existing at an upper position (root side).

According to such a configuration, by adopting the PCI Express system that is a high-speed serial bus, speed of data transfer can be increased basically. In addition to that, speed of data transfer in each of the image apparatus 1 and 2 can be increased more. That is, since the PCI Express system in each of the image apparatuses 1 and 3 forms a tree structure having the switch (3 or 4) at the top without using the root complex, data transfer among devices 5a-5k and among 6a-6e are performed without using the root complex, so that high-speed processing becomes possible.

According to the present embodiment, in the plural devices 5a-5k in the image apparatus 1, the memory 5j, the compressor 5i and the HDD 5k are determined to be devices having strong correlation with each other, and are connected to the upper switch 3 via a common switch 9, wherein the memory 5j is for temporarily storing image data, the compressor 5i is for compressing image data in the memory 5j to coded data, and the HDD 5k stores the compressed coded data.

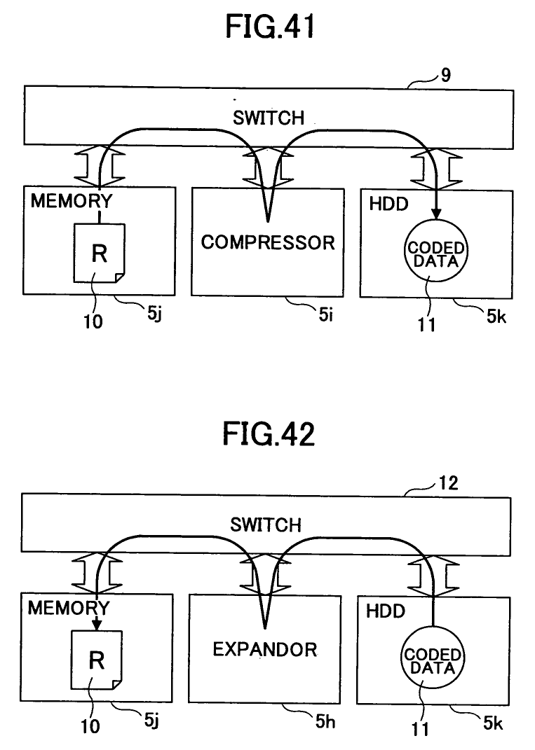

FIG. 41 is a schematic block diagram showing the devices having strong correlation. In most cases, the image data 10 stored in the memory 5j is compressed to coded data 11 to be stored in HDD 5k as jam backup. The memory 5j, the compressor 5i and the HDD 5k relating to such data transfer have very strong correlation with each other.

Since the devices with large correlation are connected to one common switch 9 without the root complex, the image data 10 in the memory 5j can be transferred to the compressor 5i via the common switch 9, and after the compressor 5i compresses the image data to coded data, the coded data can be transferred to the HDD 5k via the common switch 9 so that the coded data can be stored in the HDD 5k as jam backup (arrows in FIG. 41 shows flows of data). In this case, since data transfer can be performed without being passed through the root complex, very high-speed processing becomes possible.

Although the present invention is applied to the image system 8 systematized by the root complex 7 using the image apparatuses 1 and 2, a system configuration using one image apparatus can be adopted in the same way. In addition, instead of connecting the common switch 9 to the switch 3, the common switch 9 may be connected to the root complex 7 like the switch 3.

In addition to the examples shown in FIGS. 40 and 41, there are various examples of combinations of devices having strong correlation that is connected to a common switch. The examples are described in the following.

FIG. 42 is a schematic block diagram of an example in which the memory 5j, the expandor 5h and the HDD 5k are connected to a common switch 12 as devices having strong correlation with each other.

In most cases, in an operation mode in FIG. 42, the coded data 11 in the HDD 5k are expanded to image data by the expandor 5h so that the image data is stored in the memory 5j and the image data are printed. The HDD 5k, and the expandor 5h and the memory 5j relating to such data transfer have very strong correlation with each other.

Since the devices with large correlation are connected to one common switch 12 without using the root complex, the coded data 11 in the HDD 5k can be transferred to the expandor 5h via the common switch 12, and after the expandor 5h expands the coded data to the image data, the image data can be stored in the memory 5j by transferring to the memory 5j via the common switch 12 (arrow in FIG. 42 shows flows of data). In this case, since data transfer can be performed without being passed through the root complex, very high-speed processing becomes possible.

FIG. 43 is a schematic block diagram of an example in which the memory 5j, the compressor-expandor 5m and the HDD 5k are connected to a common switch 13 as devices having strong correlation with each other. That is, this example shows a case in which the case of FIG. 41 and the case of FIG. 42 are integrated, and the compressor-expandor 5m is used instead of the compressor 5i and the expandor 5h.

Since the devices with large correlation are connected to one common switch 13 without using the root complex, the image data 10 in the memory 5j can be transferred to the compressor-expandor 5m via the common switch 13, and after the compressor-expandor 5m compresses the image data to coded data, the coded data can be transferred to the HDD 5k via the common switch 13 so that the coded data can be stored in the HDD 5k as jam backup. In addition, in reverse, the coded data 11 in the HDD 5k can be transferred to the compressor-expandor 5m via the common switch 13, and after the compressor-expandor 5m expands the coded data to the image data, the image data can be stored in the memory 5j by transferring to the memory 5j via the common switch 12 (arrows in FIG. 43 shows flows of data). In this case, since data transfer can be performed without being passed through the root complex, very high-speed processing becomes possible.

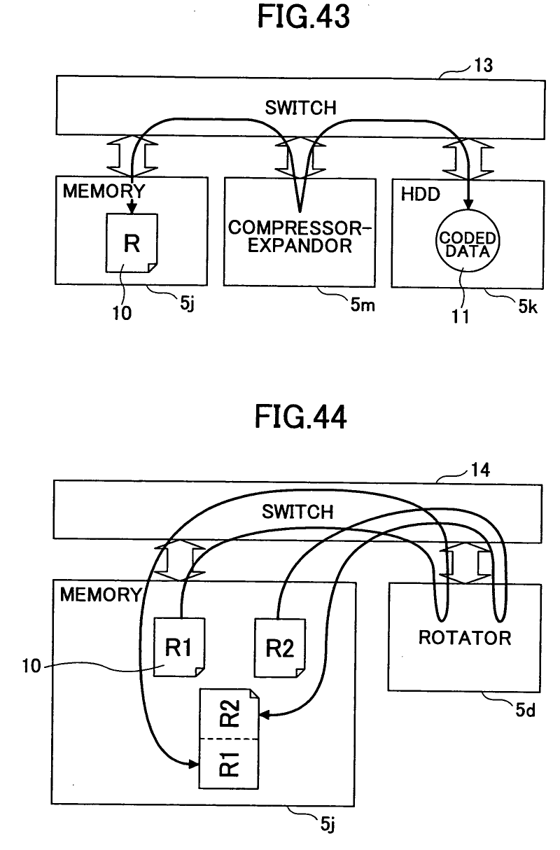

FIG. 44 is a schematic block diagram of an example in which the memory 5j and the rotator 5d are connected to a common switch 14 as devices having strong correlation with each other.

There are many cases in which the image data in the memory 5j are rotated to an output direction, and the image data are again stored in the memory 5j. Thus, the memory 5j and the rotator 5d relating to such data transfer have very strong correlation with each other.

In the example shown in the figure, the size the image data 10 (R1, R2) of two A4 documents in the memory 5j is reduced to the A5 size, and the reduced image data are put in the memory 5j. Then, the image data 10 are transferred to the rotator 5d via the common switch 14 so as to rotate each piece of the image data by 90°, and the image data are again transferred to the memory 5j via the common switch 14, so that the image data are integrated to one A4 document. In this case, since data transfer can be performed without being passed through the root complex, very high-speed processing becomes possible.

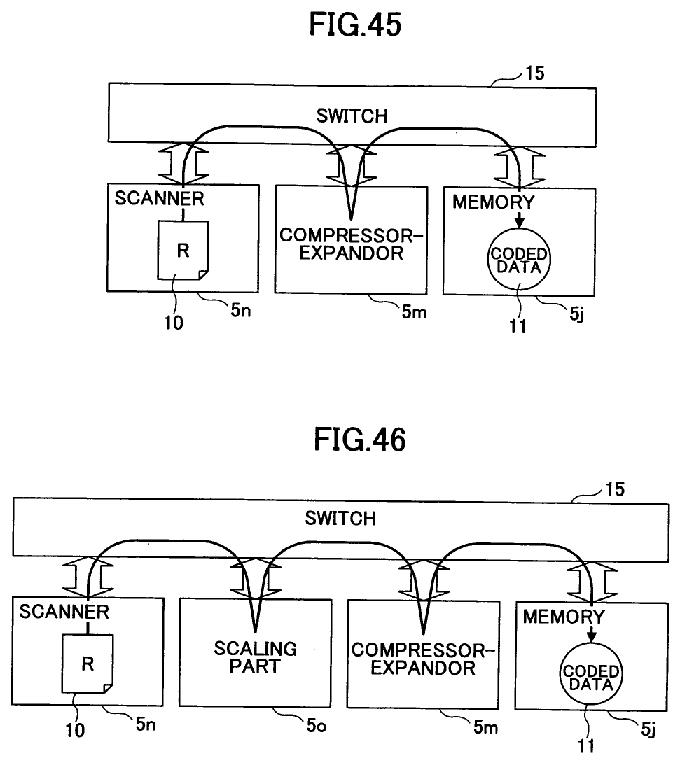

FIG. 45 is a schematic block diagram of an example in which the memory 5j, the scanner engine 5n and the compressor-expandor 5m are connected to a common switch 15 as devices having strong correlation with each other, wherein the scanner engine 5n is an example of an input part, and a device having an compress function such as the compressor 5i can be used as the compressor-expandor 5m.

There are many cases in which the image data read by the scanner engine 5n are compressed and put in the memory 5j. Thus, the scanner engine 5n, the compressor-expandor 5m and the memory 5j relating to such data transfer have very strong correlation with each other.

Since the devices with large correlation are connected to one common switch 15 without using the root complex, the image data 10 read by the scanner engine 5n can be transferred to the compressor-expandor 5m, and after the compressor-expandor 5m compresses the image data to the coded data, the coded data can be stored in the memory by transferring the coded data to the memory 5j via the common switch 15 (arrows in FIG. 45 shows flows of data). In this case, since data transfer can be performed without being passed through the root complex, very high-speed processing becomes possible.

In this case, as shown in FIG. 46, a scaling part 5o may be included in the devices having strong correlation, wherein the scaling part 5o performs a scaling process (enlarging or reducing) on the image data 10 read by the scanner engine 5n.

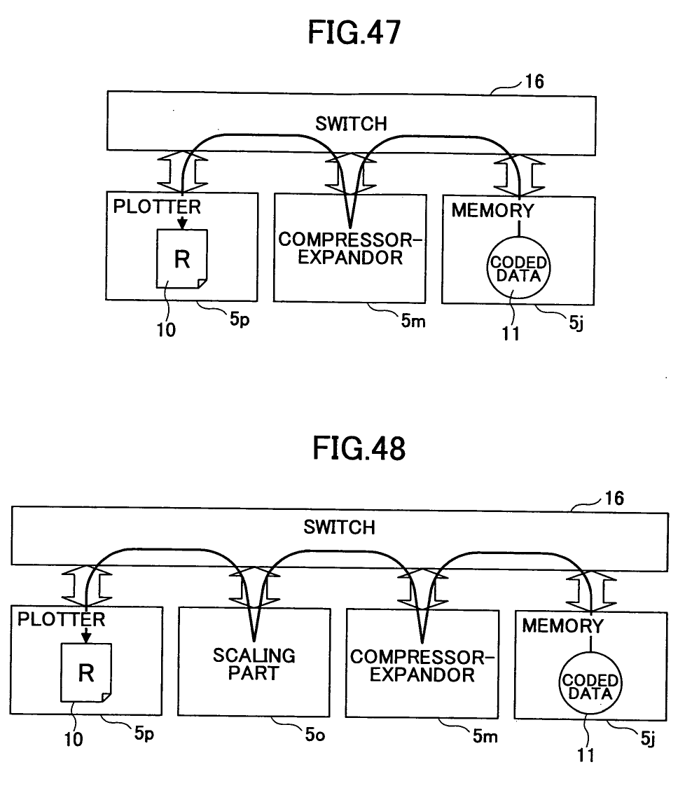

FIG. 47 is a schematic block diagram of an example in which the memory 5j, the plotter engine 5p and the compressor-expandor 5m are connected to a common switch 16 as devices having strong correlation with each other, wherein the plotter engine 5p is an example of an output part, and a device having an expansion function such as the expandor 5h can be used instead of the compressor-expandor 5m.

There are many cases in which the image data arranged in the memory 5j are printed by the plotter engine 5p after being expanded. Thus, the memory 5j, the plotter engine 5p and the compressor-expandor 5m relating to such data transfer have very strong correlation with each other.

Since the devices with large correlation are connected to one common switch 16 without using the root complex, the coded data 11 arranged in the memory 5j can be transferred to the compressor-expandor 5m via the common switch 16, and after the compressor-expander 5m expands the coded data to the image data 10, the image data can be printed by transferring the image data to the plotter engine 5p via the common switch 16 (arrows in FIG. 47 shows flows of data). In this case, since data transfer can be performed without being passed through the root complex, very high-speed processing becomes possible.

In this case, as shown in FIG. 48, a scaling part 5o may be included in the devices having strong correlation, wherein the scaling part 5o performs a scaling process (enlarging or reducing) on the image data 10 expanded by the compressor-expandor 5m.

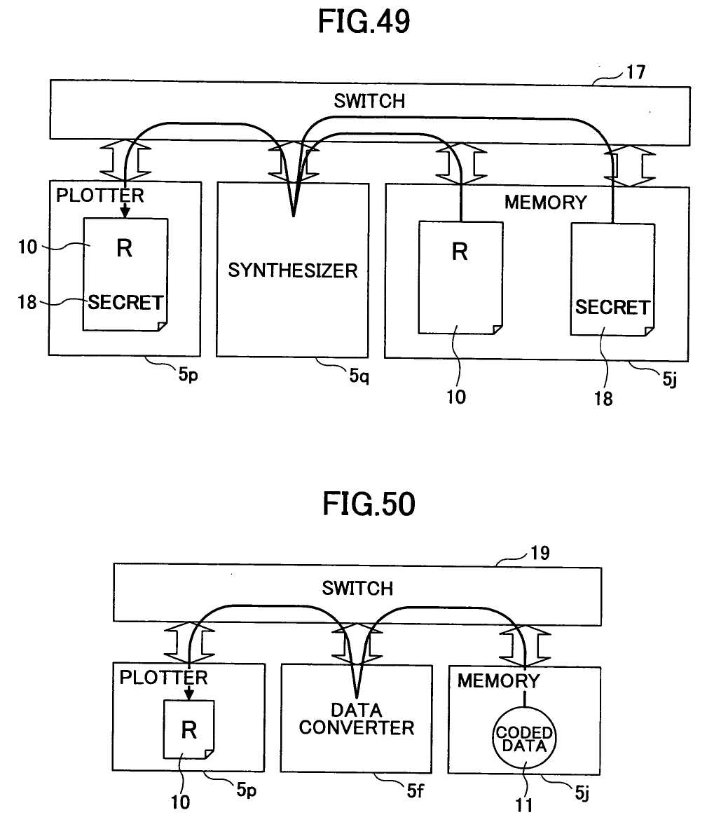

FIG. 49 is a schematic block diagram of an example in which the memory 5j, the plotter engine 5p and the image synthesizer 5g are connected to a common switch 17 as devices having strong correlation with each other, wherein the plotter engine 5p is an example of an output part.

There are many cases in which the image data 10 stored in the memory 5j and printing data 18 such as “confidential” are synthesized to be printed by the plotter engine 5p. Thus, the memory 5j, the plotter engine 5p and the image synthesizer 5g relating to such data transfer have very strong correlation with each other.

Since the devices with large correlation are connected to one common switch 17 without using the root complex, the image data 10 stored in the memory and the printing data 18 can be transferred to the image synthesizer 5g via the common switch 17, so that the image synthesizer 5g synthesizes the data and transfers the synthesized data to the plotter engine 5p via the common switch 17 so that an print output in which the image data 10 and the printing data are synthesized can be obtained (arrows in FIG. 49 shows flows of data). In this case, since data transfer can be performed without being passed through the root complex, very high-speed processing becomes possible.

FIG. 50 is a schematic block diagram of an example in which the memory 5j, the plotter engine 5p and the data converter 5f are connected to a common switch 19 as devices having strong correlation with each other, wherein the plotter engine 5p is an example of an output part.

There are many cases in which the coded data 11 (printer language) arranged in the memory 5j are translated by the data converter 5f so as to print the image data by the plotter engine 5p. Thus, the memory 5j, the plotter engine 5p and the data converter 5f relating to such data transfer have very strong correlation with each other.

Since the devices with large correlation are connected to one common switch 19 without using the root complex, the coded data 11 arranged in the memory 5j can be transferred to the data converter 5f via the common switch 19, so that the data converter 5f translates the coded data to image data, and the image data can be printed by transferring the image data to the plotter engine 5p via the common switch 19 (arrows in FIG. 50 shows flows of data). In this case, since data transfer can be performed without being passed through the root complex, very high-speed processing becomes possible.

Applications of the present invention are not limited to the above-mentioned examples, and other various combinations can be adopted.

[Considerations of Effects]

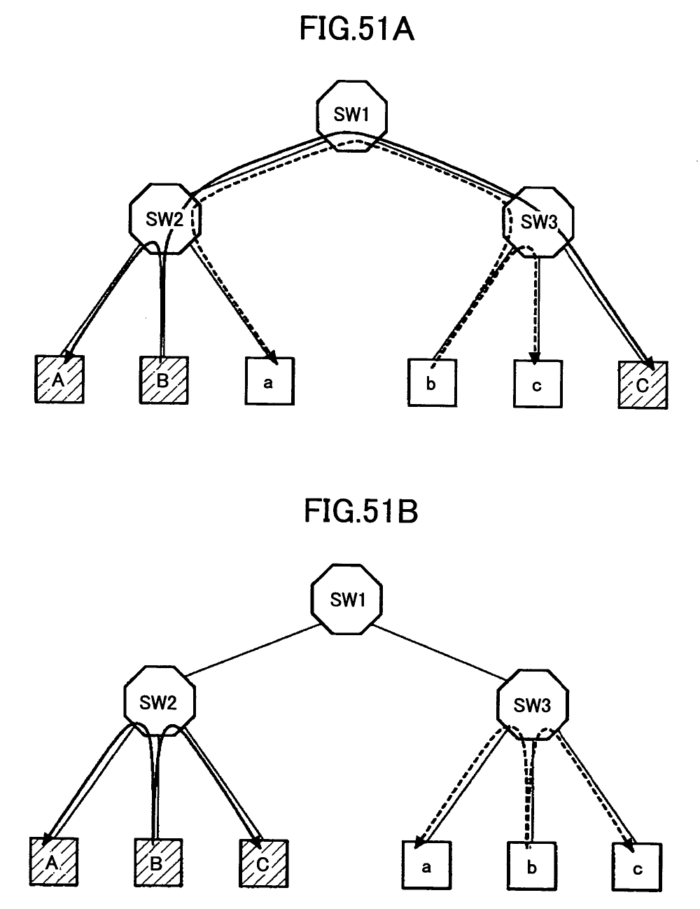

FIGS. 51A and 51B are schematic diagrams showing a conventional example and the above-mentioned configuration example having the PCI Express tree structure. In this example, devices indicated by A, B, C, a, b and c exist, and devices A, B and C have strong correlation with each other, and devices a, b and c have strong correlation with each other. In the tree structure, a switch SW1 is provided in the upper side, and switches SW2 and SW3 exist in the lower side. In addition, at the lower side of the switches SW2 and SW3, the devices A, B, C, a, b and c exist. FIG. 51A shows the conventional configuration example in which the devices A, B, C, a, b and c are connected to the switches SW2 and SW3 irrespective of the correlation. Therefore, in this system configuration, when data transfer is performed in an order of device A→device B→device C, the data transfer route becomes device A→switch SW2 , device B→switch SW2→switch SW1→switch SW3→device C, so that transferred data pass though four stages of switches. When the data transfer is performed in an order of device a→device b→device c, the data transfer route becomes device a→switch SW2→switch SW1→switch SW3→device b→switch SW3→device c, so that transferred data pass though four stages of switches. When the data transfer of these two types are performed at the same time, contention for a port occurs at three switches SW2, SW1 and SW3.

On the other hand, FIG. 51B shows a configuration example of an embodiment of the present invention in which devices having strong correlation are grouped, namely, devices A, B and C are grouped and devices a, b and c are grouped. In addition, each of the switches SW2 and SW3 is used as a common switch. More particularly, devices A, B and C are connected to the common switch SW2, and devices a, and c are connected to the common switch SW3. Therefore, in this system configuration, when data transfer is performed in an order of device A→device B→device C, the data transfer route becomes device A→switch SW2→device B→switch SW2→B device C, so that transferred data pass though two stages of switches. When the data transfer is performed in an order of device a→device b→device c, the data transfer route becomes device a→switch SW3→B device b→switch SW3→device c, so that transferred data pass though two stages of switches. Even when the data transfer of these two types are performed at the same time, contention for a port does not occur at any switch.

As to the effects of the present embodiment, in the same way as the first embodiment described with reference to FIGS. 29 and 30, since devices having strong correlation are grouped and are connected to a common switch, contention for an output port of a switch can be avoided so that the data transfer rate can be improved. In addition, according to the present embodiment, since the number of switches through which transferred data pass can be decreased as much as possible, the deterioration of the data transfer rate can be reduced.

The present invention is not limited to the specifically disclosed embodiments, and variations and modifications may be made without departing from the scope of the present invention.

The present application contains subject matter related to Japanese patent application No. 2004-324555, filed in the JPO on Nov. 9, 2004, Japanese patent application No. 2004-324556, filed in the JPO on Nov. 9, 2004, Japanese patent application No. 2004-324553, filed in the JPO on Nov. 9, 2004, Japanese patent application No. 2003-389571, filed in the JPO on Nov. 19, 2003, and Japanese patent application No. 2003-382283, filed in the JPO on Nov. 12, 2003, the entire contents of which are incorporated herein by reference.

What is claimed is:

1. A data transfer system using a high-speed serial interface system that forms a tree structure in which point-to-point communication channels are established for data sending and data receiving independently, the data transfer system comprising:
plural end points each having plural upper ports each of which is connected to a switch of an upper side, wherein each end point comprises a port selecting part for selecting a port to be used according to an operation mode of the data transfer system so as to dynamically change the tree structure.

2. The data transfer system as claimed in claim 1, wherein the high-speed serial interface system is a PCI Express system.

3. The data transfer system as claimed in claim 1, wherein the port selecting part includes a memory for rewritably storing port selection information of an upper port to be selected when reset of link is performed;
each end point further includes an updating part for updating the port selection information in the memory by receiving a message packet including the port selection information;
the data transfer system further includes:
an initialization part for performing link-up in a status in which upper ports are selected according to port selection information in the memory in each end point when the data transfer system is activated, and for obtaining the tree structure in the initial status and specifying device functions and necessary data transfer performances for each end point;
a determination part for determining an upper port optimum for the operation mode by referring to the specified device functions and the necessary data transfer performances of each end point;
a notification part for sending the message packet including the port selection information to the updating part of a corresponding end point such that the port selection information in the memory of the end point is updated; and
a re-link-up part for performing re-link-up in a status in which an upper port is selected in each end point according to the updated port selection information;
wherein the data transfer system starts to perform data transfer according to the operation mode after the re-link-up is performed.

4. The data transfer system as claimed in claim 3, wherein, when an operation mode is selected in which plural independent data transfers are processed in parallel, the determination part determines the upper port used in the end point such that contention in data transfer routes that pass through the switch does not occur.

5. The data transfer system as claimed in claim 3, wherein the determination part determines the upper port used in the end point such that the number of switches through which a data transfer route pass becomes minimum.

6. The data transfer system as claimed in claim 1, wherein the data transfer system is an image forming system in which the end points are devices relating to image processing.

7. A data transfer method performed in a data transfer system using a high-speed serial interface system that forms a tree structure in which point-to-point communication channels are established for data sending and data receiving independently, wherein the data transfer system includes plural end points each having plural upper ports each of which is connected to a switch of an upper side, the data transfer method comprising:
a port selecting step of selecting an upper port, in each end point, to be used according to an operation mode of the data transfer system so as to dynamically change the tree structure.

8. The data transfer method as claimed in claim 7, wherein the high-speed serial interface system is a PCI Express system.

9. The data transfer method as claimed in claim 7, wherein, when an operation mode is selected in which plural independent data transfers are processed in parallel, the data transfer system determines the upper port in each end point such that contention in data transfer routes that pass through the switch does not occur.

10. The data transfer method as claimed in claim 7, wherein the data transfer system determines the upper port used in each end point such that the number of switches through which a data transfer route passes becomes minimum.

11. A data transfer system using a high-speed serial interface system that forms a tree structure in which point-to-point communication channels are established for data sending and data receiving independently, the data transfer system comprising devices at a lower side of the tree structure, each of the devices comprising:
plural end points being connected to plural switches of an upper side of the tree structure; and
an arbiter for determining an end point to be used according to an operation mode of the data transfer system.

12. The data transfer system as claimed in claim 11, wherein the high-speed serial interface system is a PCI Express system.

13. The data transfer system as claimed in claim 11, wherein, when an operation mode is selected in which plural independent data transfers are processed in parallel, the arbiter determines the end point such that contention in data transfer routes that pass through the switch does not occur.

14. The data transfer system as claimed in claim 11, wherein the data transfer system is an image forming system in which the devices are devices relating to image processing.

15. The data transfer system as claimed in claim 14, wherein the devices include at least a device for inputting an image, a device for outputting an image, a device for processing an image and a storage device.

16. A data transfer method performed in a data transfer system using a high-speed serial interface system that forms a tree structure in which point-to-point communication channels are established for data sending and data receiving independently, the data transfer system comprising devices at a lower side of the tree structure, each of the devices comprising plural end points being connected to plural switches of an upper side of the tree structure, the data transfer method comprising:
an arbitration step of determining an end point to be used according to an operation mode of the data transfer system.

17. The data transfer method as claimed in claim 16, wherein the high-speed serial interface system is a PCI Express system.

18. The data transfer method as claimed in claim 16, wherein, when an operation mode is selected in which plural independent data transfers are processed in parallel, the end point is determined such that contention in data transfer routes that pass through the switch does not occur.

19. A data transfer system using a high-speed serial interface system that forms a tree structure in which point-to-point communication channels are established for data sending and data receiving independently, the data transfer system comprising devices at a lower side of the tree structure, each of the devices comprising:
plural end points being connected to plural switches of an upper side of the tree structure;
an arbiter for determining an end point to be used for accessing-other device; and
an information storing part for storing information on a device function of the own device and information on end points such that a management part of the data transfer system can access the information,
the management part of the data transfer system comprising:
a determination part for determining an optimum route between devices in the tree structure based on a device connection status, the information on the device function and the information on the end points obtained from each device; and
a setting part for setting the determined route information in each device,
wherein the arbiter in each device determines the end point used for accessing other device by referring to the determined route information set by the setting part.

20. A data transfer system using a high-speed serial interface system that forms a tree structure in which point-to-point communication channels are established for data sending and data receiving independently, the data transfer system comprising devices at a lower side of the tree structure, each of the devices comprising:
plural end points being connected to plural switches of an upper side of the tree structure; and
an arbiter for determining an end point to be used for accessing other device,
the data transfer system further comprising an management part including:
an information management part for storing information on a device function of each device and information on end points;
a determination part for determining an optimum route between devices in the tree structure based on a device connection status, the information on the device function and the information on the end points stored in the information management part; and
a setting part for setting the determined route information in each device,
wherein the arbiter in each device determines the end point used for accessing other device by referring to the determined route information set by the setting part.

21. The data transfer system as claimed in claim 19, wherein the high-speed serial interface system is a PCI Express system.

22. The data transfer system as claimed in claim 19, wherein the information on the end points includes the number of end points, the number of lanes of each end point, and information on a connection destination of each end point.

23. The data transfer system as claimed in claim 19, wherein the setting part writes the route information in the device when the data transfer system is activated.

24. The data transfer system as claimed in claim 23, wherein the setting part writes a default value in the device as the route information when the data transfer system is activated.

25. The data transfer system as claimed in claim 23, wherein, when the management part receives information on change of an operation mode while the data transfer system is being activated, the management part re-determines the route between the devices such that the route becomes optimum for the operation mode, and the setting part writes the re-determined route information in each device.

26. The data transfer system as claimed in claim 23, wherein the management part periodically re-determines the route between the devices such that the route becomes optimum, and the setting part writes the re-determined route information in each device.

27. The data transfer system as claimed in claim 25, wherein each device further comprising a transaction issuing part for issuing a message transaction for requesting the management part to re-determine the route information when the device receives the information on change of the operation mode, and
the management part receives the information on the change of the operation mode by receiving the message transaction that includes the information on the change.

28. The data transfer system as claimed in claim 25, wherein each device further comprising a transaction issuing part for issuing a message transaction for requesting the management part to re-determine the route information when the device receives the information on change of the operation mode, and
the management part receives the information on the change of the operation mode by referring, in response to receiving the message transaction, to the information on the change that is stored in the device.

29. The data transfer system as claimed in claim 19, wherein the management part further includes a monitoring part for monitoring addition or deletion of a device while the data transfer system is being activated, and the determination part determines the route in parallel to addition or deletion of the device.

30. The data transfer system as claimed in claim 19, wherein the data transfer system is an image forming system in which the devices are devices relating to image processing.

31. The data transfer system as claimed in claim 30, wherein the devices includes at least a device for inputting an image, a device for outputting an image, a device for processing an image and a storage device.

32. A computer program for causing a computer for managing a data transfer system to perform processes, wherein the data transfer system uses a high-speed serial interface system that forms a tree structure in which point-to-point communication channels are established for data sending and data receiving independently, the data transfer system comprising devices at a lower side of the tree structure, each of the devices comprising:
plural end points being connected to plural switches of an upper side of the tree structure;
an arbiter for determining an end point to be used for accessing other device; and
an information storing part for storing information on a device function of the own device and information on end points,
the computer program comprising:
determination program code means for determining an optimum route between devices in the tree structure based on a device connection status, the information on the device function and the information on the end points obtained from each device; and
setting program code means for setting the determined route information in each device.

33. A computer program for causing a computer for managing a data transfer system to perform processes, wherein the data transfer system uses a high-speed serial interface system that forms a tree structure in which point-to-point communication channels are established for data sending and data receiving independently, the data transfer system comprising devices at a lower side of the tree structure, each of the devices comprising:
plural end points being connected to plural switches of an upper side of the tree structure; and
an arbiter for determining an end point to be used for accessing other device,
the computer program comprising:
information management program code means for storing information on a device function of each device and information on end points in a storage;
determination program code means for determining an optimum route between devices in the tree structure based on a device connection status, the information on the device function and the information on the end points managed by the information management program code means; and
setting program code means for setting the determined route information in each device.

34. The computer program as claimed in claim 32, wherein the high-speed serial interface system is a PCI Express system.

35. The computer program as claimed in claim 32, wherein the information on the end points includes the number of end points, the number of lanes of each end point, and information on a connection destination of each end point.

36. The computer program as claimed in claim 32, wherein the setting program code means writes the route information in the device when the data transfer system is activated.

37. The computer program as claimed in claim 36, wherein the setting program code means writes a default value in the device as the route information when the data transfer system is activated.

38. The computer program as claimed in claim 36, wherein, when the computer receives information on change of an operation mode while the data transfer system is being activated, the computer program causes the computer to re-determine the route between the devices such that the route becomes optimum for the operation mode, and the setting program code means writes the re-determined route information in each device.

39. The computer program as claimed in claim 36, wherein the computer program causes the computer to periodically re-determine the route between the devices such that the route becomes optimum, and the setting program code means writes the re-determined route information in each device.

40. The computer program as claimed in claim 38, wherein each device further comprising a transaction issuing part for issuing a message transaction for requesting the computer to re-determine the route information when the device receives the information on change of the operation mode, and
the computer program causes the computer to receive the information on the change of the operation mode by receiving the message transaction that includes the information on the change.

41. The computer program as claimed in claim 38, wherein each device further comprising a transaction issuing part for issuing a message transaction for requesting the computer to re-determine the route information when the device receives the information on change of the operation mode, and
the computer program causes the computer to receive the information on the change of the operation mode by referring, in response to receiving the message transaction, to the information on the change that is stored in the device.

42. The computer program as claimed in claim 32, wherein the computer program further includes monitoring program code means for monitoring addition or deletion of a device while the data transfer system is being activated, and the determination program code means determines the route in parallel to addition or deletion of the device.

43. An image apparatus system using a high-speed serial interface system that forms a tree structure in which point-to-point communication channels are established for data sending and data receiving independently, the image apparatus system comprising:
plural image apparatuses having different performance, wherein each of the plural image apparatuses is connected to a switch, and includes devices at least including a control part and a storage; and
a root complex to which plural switches are commonly connected.

44. The image apparatus system as claimed in claim 43, wherein the high-speed serial interface system is a PCI Express system.

45. The image apparatus system as claimed in claim 43, wherein the image apparatus system includes plural root complexes, and an advanced switch to which the plural root complexes are commonly connected.

46. The image apparatus system as claimed in claim 43, wherein the plural image apparatuses include a first image apparatus having a speed performance and a second image apparatus having a speed performance lower than that of the first image apparatus.

47. The image apparatus system as claimed in claim 43, wherein the plural image apparatuses include a color image apparatus and a black and white image apparatus.

48. The image apparatus system as claimed in claim 43, wherein the plural image apparatuses include an image apparatus including a laser printer and an image apparatus including a inkjet printer.

49. The image apparatus system as claimed in claim 43, wherein the plural image apparatuses include an wide width image apparatus and a A3 size image apparatus.

50. The image apparatus system as claimed in claim 43, wherein devices having strong correlation with each other are connected to the switch via a common switch at a lower side.

51. An image system using a high-speed serial interface system that forms a tree structure in which point-to-point communication channels are established for data sending and data receiving independently, the image system comprising plural devices existing at end points in a lower side of the tree structure,
wherein, in the plural devices, particular devices having strong correlation with each other are connected to an upper side via a common switch.

52. The image system as claimed in claim 51, wherein the high-speed serial interface system is a PCI Express system.

53. The image system as claimed in claim 51, wherein the devices having strong correlation are a memory for storing temporarily image data, an compressor for compressing the image data in the memory into coded data, and a hard disk drive for storing the compressed coded data.

54. The image system as claimed in claim 51, wherein the devices having strong correlation are a hard disk drive for storing compressed coded data, an expandor for expanding the coded data in the hard disk drive to image data, and a memory for storing the expanded image data.

55. The image system as claimed in claim 51, wherein the devices having strong correlation are a memory for temporarily storing image data, an compressor-expandor for compressing the image data to coded data and expanding the coded data to the image data, and a hard disk drive for storing the compressed coded data.

56. The image system as claimed in claim 51, wherein the devices having strong correlation are a memory for temporarily storing image data, and a rotator for performing a rotation process on the image data.

57. The image system as claimed in claim 51, wherein the devices having strong correlation are an input part for inputting image data, a device having a compressing function for compressing the input image data to coded data, and a memory for temporarily storing the compressed coded data.

58. The image system as claimed in claim 57, wherein the devices having strong correlation further include a scaling device for enlarging and reducing image data.

59. The image system as claimed in claim 51, wherein the devices having strong correlation are a memory for temporarily storing compressed coded data, a device having a expanding function for expanding the coded data to image data, and an output device for performing printing based on the expanded image data.

60. The image system as claimed in claim 57, wherein the devices having strong correlation further include a scaling device for enlarging and reducing the expanded image data.

61. The image system as claimed in claim 51, wherein the devices having strong correlation are a memory for temporarily storing image data and printing data, a synthesizer for synthesizing the image data and the printing data, and an output device for performing printing based on the synthesized data.

62. The image system as claimed in claim 51, wherein the devices having strong correlation are a memory for storing coded data based on a printer language, a data converter for translating the coded data to image data, and an output device for performing printing based on the image data.
